(19) United States
(12) Patent Application Publication
(10) Pub. No.: US 2025/0099888 A1
(43) Pub. Date: Mar. 27, 2025

(54) FILTER MEDIA INCLUDING A WAVED FILTRATION LAYER HAVING A GRADIENT

(71) Applicant: Hollingsworth & Vose Company, East Walpole, MA (US)

(72) Inventors: David T. Healey, Bellingham, MA (US); Bruce Smith, Copper Hill, VA (US); Arash Sahbaee, Christiansburg, VA (US); Mark A. Gallimore, Floyd, VA (US); Maxim Silin, Hudson, MA (US)

(73) Assignee: Hollingsworth & Vose Company, East Walpole, MA (US)

(21) Appl. No.: 18/913,254

(22) Filed: Oct. 11, 2024

Related U.S. Application Data
(62) Division of application No. 15/466,809, filed on Mar. 22, 2017.

(51) Int. Cl. B01D 39/16; B01D 39/18

(52) U.S. Cl. CPC B01D 39/163; B01D 39/18; B01D 2239/0622; B01D 2239/0631; B01D 2239/065; B01D 2239/069; B01D 2239/1233

(57) ABSTRACT

Filter media comprising a waved filtration layer having a gradient in a property and associated methods are provided. The waved filtration layer may include fibers that form one or more fiber webs. In some embodiments, the diameter of the fibers may vary across at least a portion of the thickness of the waved filtration layer to produce a gradient in fiber diameter. The gradient may be designed to impart beneficial properties to the filter media, such as low pressure drop and long lifetime. In some embodiments, the gradient may be characterized by mathematical equations that describe the change in fiber diameter across at least a portion of the thickness of the waved filtration layer. The filter media, described herein, may be particularly well-suited for applications that involve filtering liquids, though the media may also be used in other applications.

### RELATED APPLICATIONS

This application is a division of U.S. application Ser. No. 15/466,809, filed Mar. 22, 2017, which is incorporated herein by reference in its entirety.

### FIELD OF INVENTION

The present embodiments relate generally to filter media, and more specifically, to filter media comprising a waved filtration layer having a gradient in a property.

### BACKGROUND

Filter elements can be used to remove contamination in a variety of applications. Such elements can include a filter media which may be formed of a web of fibers. The filter media provides a porous structure that permits fluid (e.g., gas, liquid) to flow through the media. Contaminant particles (e.g., dust particles, soot particles) contained within the fluid may be trapped on or in the filter media. Depending on the application, the filter media may be designed to have different performance characteristics.

### SUMMARY OF THE INVENTION

Filter media comprising a waved filtration layer having a gradient in a property, and related components, systems, and methods associated therewith are provided.

In one set of embodiments, filter media are provided. In one embodiment, a filter media, comprises a filtration layer comprising a coarse fiber web positioned adjacent to a fine fiber web, and a support layer that holds the filtration layer in a waved configuration and maintains separation of peaks and troughs of adjacent waves of the filtration layer. The fine fiber web has an average fiber diameter of greater than or equal to about 0.02 microns and less than or equal to about 0.3 microns and has a basis weight of greater than or equal to about 0.01 g/m² and less than or equal to about 3 g/m², and the coarse fiber web has an average fiber diameter of greater than or equal to about 0.1 microns and less than or equal to about 30 microns and has a basis weight of greater than or equal to about 2 g/m² and less than or equal to about 30 g/m². The average fiber diameter of the fine fiber web is less than the average fiber diameter of the coarse fiber web, and the filter media has an initial pressure drop of greater than or equal to about 1.0 mm H₂O and less than or equal to about 15.0 mm H₂O.

In another embodiment, a filter media comprises a filtration layer comprising a coarse fiber layer comprising a first coarse fiber web and a second coarse fiber web positioned adjacent to a fine fiber web, and a support layer that holds the filtration layer in a waved configuration and maintains separation of peaks and troughs of adjacent waves of the filtration layer, wherein the fine fiber web has an average fiber diameter of greater than or equal to about 0.02 microns and less than or equal to about 0.3 microns and has a basis weight of greater than or equal to about 0.01 g/m² and less than or equal to about 3 g/m². The average fiber diameter at four or more locations along a thickness of the coarse fiber layer is greater than or equal to any exponential function having the form:

$$\frac{{B}_{min}}{{( exp ( {A}_{max} * x ) )}^{2}}$$

and less than or equal to any exponential function having the form:

$$\frac{{B}_{max}}{{( exp ( {A}_{min} * x ) )}^{2}}$$

wherein:
   Bₘᵢₙ is greater than or equal to about 1 micron and less than or equal to about 2 microns,
   Bₘₐₓ is greater than or equal to about 5 microns and less than or equal to about 15 microns,
   Aₘᵢₙ is greater than about 0 and less than or equal to about 0.4,
   Aₘₐₓ is greater than or equal to about 0.7 and less than or equal to about 1.5,
   x corresponds to a location along a thickness of at least a portion of the filtration layer and is normalized to have a value greater than or equal to 0 and less than or equal to 1, and
      wherein the four or more locations along the thickness of the coarse fiber layer comprises a top surface location and a bottom surface location of the first coarse fiber web and a top surface location and a bottom surface location of the second coarse fiber web.

In one embodiment, a filter media comprises a filtration layer comprising a coarse fiber layer comprising a first coarse fiber web and a second coarse fiber web positioned adjacent to a fine fiber web, wherein the fine fiber web has an average fiber diameter of greater than or equal to about 0.02 microns and less than or equal to about 0.3 microns and has a basis weight of greater than or equal to about 0.01 g/m² and less than or equal to about 3 g/m², and a support layer that holds the filtration layer in a waved configuration and maintains separation of peaks and troughs of adjacent waves of the filtration layer. The average fiber diameter at two or more locations along an thickness of the coarse fiber layer is greater than or equal to any exponential function having the form:

$$\frac{{B}_{min}}{{( exp ( {A}_{max} * x ) )}^{2}}$$

and less than or equal to any exponential function having the form:

$$\frac{{B}_{max}}{{( exp ( {A}_{min} * x ) )}^{2}}$$

wherein:
   Bₘᵢₙ is greater than or equal to about 1 micron and less than or equal to about 2 microns,
   Bₘₐₓ is greater than or equal to about 5 microns and less than or equal to about 15 microns,
   Aₘᵢₙ is greater than about 0 and less than or equal to about 0.4,
   Aₘₐₓ is greater than or equal to about 0.7 and less than or equal to about 1.5,
   x corresponds to a location along a thickness of at least a portion of the filtration layer and is normalized to have a value greater than or equal to 0 and less than or equal to 1, and
      wherein the two or more locations along the thickness of the coarse fiber layer comprises a half thickness location of the first coarse fiber web and a half thickness location of the second coarse fiber web.

In another embodiment, a filter media comprises a filtration layer comprising a coarse fiber web positioned adjacent to a fine fiber web and a support layer that holds the filtration layer in a waved configuration and maintains separation of peaks and troughs of adjacent waves of the filtration layer. The average fiber diameter at two or more locations along a thickness of the fine fiber web and an average fiber diameter at two or more locations along a thickness of the coarse fiber web is greater than or equal to any exponential function having the form:

$$\frac{{B}_{max}}{{( exp ( {A}_{min} * x ) )}^{2}}$$

and less than or equal to any exponential function having the form:

$$\frac{{B}_{max}}{{( exp ( {A}_{min} * x ) )}^{2}}$$

wherein:
   Bₘᵢₙ is greater than or equal to about 1.5 microns and less than or equal to about 3 microns,
   Bₘₐₓ is greater than or equal to about 12 microns and less than or equal to about 30 microns,
   Aₘᵢₙ is greater than about 0 and less than or equal to about 1.2,
   Aₘₐₓ is greater than or equal to about 1.4 and less than or equal to about 1.75,
   x corresponds to a location along a thickness of at least a portion of the filtration layer and is normalized to have a value greater than or equal to 0 and less than or equal to 1, and
      wherein the two or more locations along the thickness of the fine fiber web comprises a top surface location and a bottom surface location, and the two or more locations along the thickness of the coarse fiber web comprises a top surface location and a bottom surface location.

In one embodiment, a filter media comprises a filtration layer comprising a coarse fiber web positioned adjacent to a fine fiber web, and a support layer that holds the filtration layer in a waved configuration and maintains separation of peaks and troughs of adjacent waves of the filtration layer. The average fiber diameter at one or more locations along an thickness of the fine fiber web and an average fiber diameter at one or more locations along an thickness of the coarse fiber web is greater than or equal to any exponential function having the form:

$$\frac{{B}_{max}}{{( exp ( {A}_{min} * x ) )}^{2}}$$

and less than or equal to any exponential function having the form:

$$\frac{{B}_{max}}{{( exp ( {A}_{min} * x ) )}^{2}}$$

wherein:
   Bₘᵢₙ is greater than or equal to about 1.5 microns and less than or equal to about 3 microns,
   Bₘₐₓ is greater than or equal to about 12 microns and less than or equal to about 30 microns,
   Aₘᵢₙ is greater than about 0 and less than or equal to about 1.2,
   Aₘₐₓ is greater than or equal to about 1.4 and less than or equal to about 1.75,
   x corresponds to a location along an thickness of at least a portion the filtration layer and is normalized to have a value greater than or equal to 0 and less than or equal to 1, and
      wherein the one or more locations along the thickness of the fine fiber web comprises a half thickness location of the fine fiber web, and the one or more locations along the thickness of the coarse fiber web comprises a half thickness location of the coarse fiber web.

In another embodiment, a filter media comprises a filtration layer, and a support layer that holds the filtration layer in a waved configuration and maintains separation of peaks and troughs of adjacent waves of the filtration layer. The average fiber diameter at three or more locations along an thickness of the filtration layer is greater than or equal to any exponential function having the form:

$$\frac{{B}_{max}}{{( exp ( {A}_{min} * x ) )}^{2}}$$

and less than or equal to any exponential function having the form:

$$\frac{{B}_{max}}{{( exp ( {A}_{min} * x ) )}^{2}}$$

wherein:
   Bₘᵢₙ is greater than or equal to about 1.5 microns and less than or equal to about 3 microns,
   Bₘₐₓ is greater than or equal to about 12 microns and less than or equal to about 30 microns,
   Aₘᵢₙ is greater than about 0 and less than or equal to about 1.2,
   Aₘₐₓ is greater than or equal to about 1.4 and less than or equal to about 1.75,
   x corresponds to a location along a thickness of at least a portion of the filtration layer and is normalized to have a value greater than or equal to 0 and less than or equal to 1, and
      wherein the three or more locations along the thickness of the filtration layer comprises x is 0.25, x is 0.5, and x is 0.75.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a schematic of a filter media according to certain embodiments;

FIG. 1B is a schematic of a filter media according to certain embodiments;

FIG. 1C is a schematic of a filter media according to certain embodiments;

FIG. 2 is a schematic of the area between two mathematical functions on a graph of average fiber diameter versus normalized thickness;

FIG. 3 is a plot of average fiber diameter versus normalized thickness and a schematic of a filter media having a gradient in a property across the filtration layer, according to one set of embodiments;

FIG. 4 is a plot of average fiber diameter versus normalized thickness and a schematic of a filter media having a gradient in a property across the filtration layer, according to one set of embodiments;

FIG. 5 is a plot of average fiber diameter versus normalized thickness and a schematic of a filter media having a gradient in a property across the filtration layer, according to one set of embodiments;

FIG. 6 is a plot of average fiber diameter versus normalized thickness and a schematic of a filter media having a gradient in a property across the coarse fiber layer, according to one set of embodiments;

FIG. 7 is a plot of average fiber diameter versus normalized thickness and a schematic of a filter media having a gradient in a property across the coarse fiber layer, according to one set of embodiments;

FIG. 8A is a side view illustration of one embodiment of a filter media;

FIG. 8B is a side view illustration of another embodiment of a filter media;

FIG. 9 is a side view illustration of one layer of the filter media of FIG. 8A;

FIG. 10 is a plot of pressure drop versus time for various filter media, according to one set of embodiments;

FIG. 11 is a plot of pressure drop versus dust feed for various filter media, according to one set of embodiments; and

FIG. 12 is a plot of average fiber diameter versus dimensionless thickness for various filter media, according to one set of embodiments.

### DETAILED DESCRIPTION

Filter media comprising a waved filtration layer having a gradient in a property and associated methods are provided. The waved filtration layer may include fibers that form one or more fiber webs. In some embodiments, the diameter of the fibers may vary across at least a portion of the thickness of the waved filtration layer to produce a gradient in fiber diameter. The gradient may be designed to impart beneficial properties to the filter media, such as low pressure drop and long lifetime. In some embodiments, the gradient may be characterized by mathematical equations that describe the change in fiber diameter across at least a portion of the thickness of the waved filtration layer. For instance, a gradient having a fiber diameter at two or more locations along the thickness of the filtration layer that falls within the area between two convex functions (e.g., exponential functions) may impart a relatively low pressure drop to the filter media. The filter media, described herein, may be particularly well-suited for applications that involve filtering air, though the media may also be used in other applications (e.g., liquids).

Many filtration applications require the filter media to meet certain efficiency standards. In some existing filter media, a tradeoff exists between adequate particulate efficiency and low pressure drop, and accordingly long service life. Some conventional filter media achieve the requisite efficiency by using certain pre-filter layers or structural changes that adversely affect the pressure drop of the filter media. For instance, the thickness and/or solidity of certain conventional pre-filter layers may cause the pressure drop of the filter media to increase. In some conventional media, adequate efficiency may be achieved by changing a structural characteristic (e.g., mean fiber diameter, mean flow pore size, porosity, basis weight) of a filtration layer within the filter media. However, the structural changes may substantially diminish the ability of the filtration layer to trap certain particles that have a propensity to clog one or more downstream layers within the filter media or may result in the filtration layer having a surface filtration mechanism, in which particles are primarily trapped on the dust cake formed on the upstream surface of the filtration layer and, as a result, the filter media may have a higher pressure drop and increase in pressure drop during filtration. Accordingly, there is a need for filter media that can achieve the requisite particulate efficiency for a given application without sacrificing pressure drop and/or service life.

In some embodiments, a waved filtration layer having a certain gradient in fiber diameter can be used to produce a filter media having the requisite particulate efficiency with relatively minimal or no adverse effects on other properties of the filter media. A filter media comprising such a waved filtration layer, as described herein, may not suffer from one or more limitations of conventional filter media. As described further below, certain gradients in fiber diameter may allow the waved filtration layer to have a depth filtration mechanism, in which particles are trapped within and throughout the filtration layer, resulting in a relatively low pressure drop, a relatively low increase in pressure drop overtime, and a long service life. Moreover, in certain embodiments, the waved filtration layer may have a relatively low basis weight and/or thickness that further contribute to the overall low pressure drop (e.g., low initial pressure drop). Filter media comprising a waved filtration layer, as described herein, may be used to meet certain particulate efficiency standards while also having a desirable pressure drop, change in pressure drop over time, dust holding capacity, and/or service life, amongst other beneficial properties.

In some embodiments, a filter media may comprise a filtration layer having a gradient in a property (e.g., average fiber diameter) and a support layer that holds the filtration layer in a waved configuration and maintains separation of peaks and troughs of adjacent waves of the filtration layer. The waved filtration layer may include one or more fiber webs. In some embodiments, the filtration layer may include a single fiber web having a gradient. In other embodiments, the filtration layer may comprise two or more fiber webs (e.g., two fiber webs, three fiber webs, four or more fiber webs) with each web having respective fiber diameters such that, when combined, form a gradient, e.g., in fiber diameter.

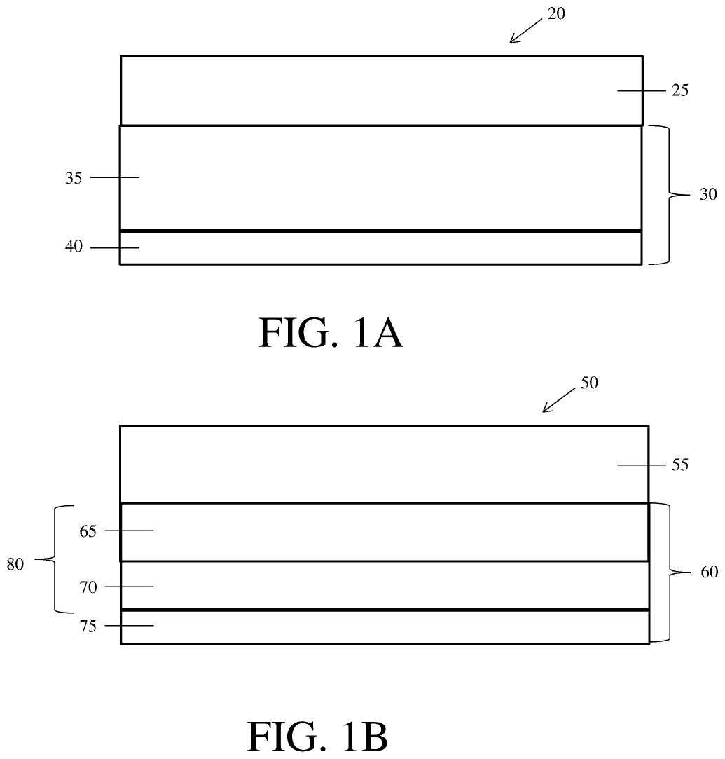

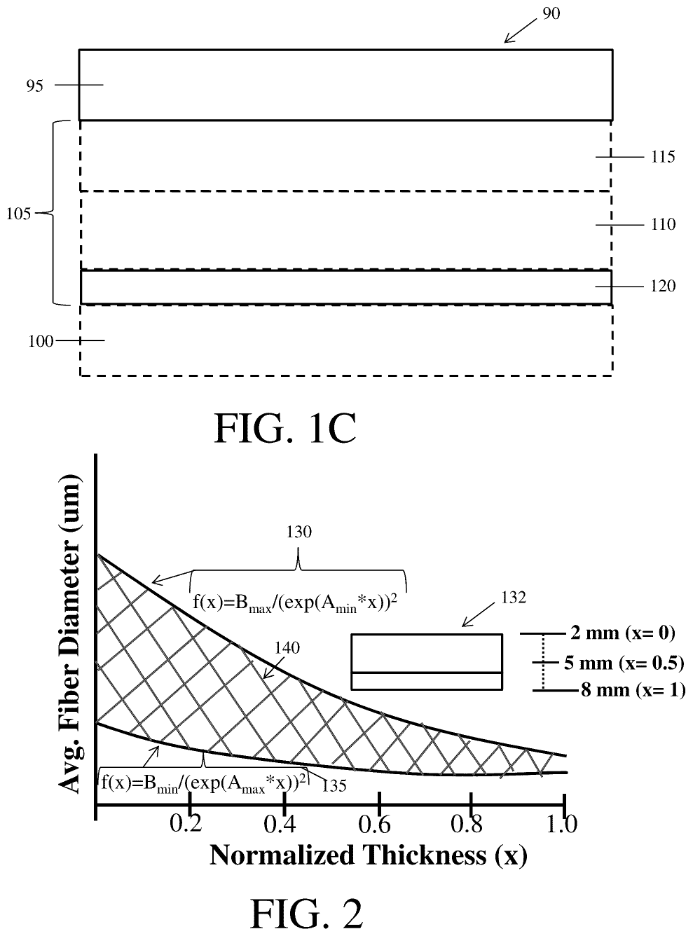

It should be understood that the planar configurations of at least some of the webs and layers (e.g., all of the fiber webs and layers) shown in FIGS. 1A-1C are for ease of illustration only. In general, the filter media, described herein, comprises a filtration layer that is held in a waved or curvilinear configuration by one or more support layers.

For instance, as illustrated in FIG. 1A, a filter media 20 may include a support layer 25 and a filtration layer 30 comprising two fiber webs. Filtration layer 30 may include a coarse fiber web 35 directly or indirectly adjacent to (e.g., upstream of) a fine fiber web 40 that form a gradient, e.g., in fiber diameter. As used herein, “fine fiber web” refers to the fiber web having the smallest average fiber diameter of the fiber webs in the filtration layer. The term “coarse fiber web” refers to a fiber web within the filtration layer that has a larger average fiber diameter than the fine fiber web. As noted below, the filtration layer may include more than one coarse fiber web. It should be understood that the terms “upstream” and “downstream” are used to describe the relative arrangement of a layer or web with respect to the direction of flow of the fluid to be filtered and are determined when the filter media is oriented to achieve desirable filtration properties, such as when the filter media is incorporated into a filter element. An upstream layer comes in contact with the fluid to be filtered before a downstream layer.

As described further below, in some embodiments, the coarse and/or fine fiber webs may comprise synthetic fibers. For instance the coarse fiber web and/or fine fiber web may be formed by a meltblowing process. In some instances, the fine fiber web may be formed by an electrospinning process. In other instances, the fine fiber web may be formed by a meltblowing process. In some embodiments, coarse fiber web 35 may be positioned between support layer 25 and fine fiber web 40. In some such embodiments, coarse fiber web 35 may be directly adjacent to support layer 25 and/or fine fiber web 40 as shown in FIG. 1A. In other such embodiments, one or more intervening fiber web (e.g., carded fiber web, airlaid fiber web) may be positioned between coarse fiber web 35 and support layer 25 and/or fine fiber web 40. Support layer 25 may be positioned upstream of filtration layer 30, as shown in FIG. 1A, or downstream of filtration layer 30. As used herein, when a layer or fiber web is referred to as being “directly adjacent” to another layer or fiber web, it means that no intervening layer or web is present. When a layer or fiber web is referred to as being “indirectly adjacent” to another layer or fiber web, it means that one or more intervening layers or webs are present.

In one example, in which the filtration layer includes a coarse fiber web directly or indirectly adjacent to (e.g., upstream of) a fine fiber web, the fine fiber web (e.g., electrospun fiber web) may have an average fiber diameter (e.g., greater than or equal to about 0.02 microns and less than or equal to about 0.3 microns) that is less than the average fiber diameter (e.g., greater than or equal to about 0.1 microns and less than or equal to about 30 microns) of the coarse fiber web. In some such cases, the fine fiber web may have a relatively low basis weight (e.g., greater than or equal to 0.01 g/m² and less than or equal to about 3 g/m²) and/or the coarse fiber web may have a relatively low basis weight (e.g., greater than or equal to 2 g/m² and less than or equal to about 30 g/m²). A filter media comprising such a filtration layer may have a relatively low pressure drop over time and low initial low pressure drop (e.g., greater than or equal to about 1.0 mm H₂O and less than or equal to about 15.0 mm H₂O).

In another example, in which the filtration layer includes a coarse fiber web directly or indirectly adjacent to (e.g., upstream of) a fine fiber web, coarse fiber web 35 and fine fiber web 40 may form a gradient in average fiber diameter in filtration layer 30 that can be characterized by two convex functions (e.g., exponential functions). In some such embodiments, the average fiber diameters at two or more locations along at least a portion of the thickness of filtration layer 30 may fall within the area defined by the convex functions, as described in more detail below.

In some embodiments, a filtration layer may comprise three fiber webs. For instance, as illustrated in FIG. 1B, a filter media 50 may include support layer 55 and a filtration layer 60 comprising three fiber webs. In some embodiments, filtration layer 60 may include a first coarse fiber web 65 and a second coarse fiber web 70 directly or indirectly adjacent to (e.g., upstream of) a fine fiber web 75. As described further below, in some embodiments, the first coarse fiber web, second coarse fiber web, and/or fine fiber web may comprise synthetic fibers. For instance, the first coarse fiber web and the second coarse fiber may be formed by a meltblowing process. In some instances, the fine fiber web may be formed by an electrospinning process. In other instances, the fine fiber web may be formed by a meltblowing process. In other embodiments, one or more coarse fiber webs may be formed via a dry laid process (e.g., carding process). In certain embodiments, second coarse fiber web 70 may be positioned between first coarse fiber web 65 and fine fiber web 75. In some such embodiments, second coarse fiber web 70 may be directly adjacent to first coarse fiber web 65 and/or fine fiber web 75 as shown in FIG. 1B. In other such embodiments, one or more intervening fiber web (e.g., meltblown fiber web, carded fiber web) may be positioned between second coarse fiber web 70 and first coarse fiber web 60 and/or fine fiber web 75.

In some embodiments, first coarse fiber web 65 and second coarse fiber web 70 may form a coarse fiber layer 80 having a gradient, e.g., in fiber diameter along the thickness of the coarse fiber layer. The gradient along coarse fiber layer 80 may be characterized by two mathematical functions (e.g., exponential functions), such that, e.g., the average fiber diameter at two or more locations along the thickness of coarse layer 80 falls within the area defined by the mathematical functions. In some such cases, the gradient may be across only a portion (e.g., across coarse fiber layer 80) of the thickness of filtration layer 60. In other cases in which coarse fiber layer 80 has a gradient characterized by mathematical functions, the gradient may be across substantially all of the thickness of filtration layer 60. In some embodiments, coarse fiber layer 80 may be positioned between support layer 55 and fine fiber web 75. In some such embodiments, coarse fiber layer 80 may be directly adjacent to support layer 55 and/or fine fiber web 75. In other such embodiments, one or more intervening fiber web may be positioned between coarse fiber layer 80 and support layer 55 and/or fine fiber web 75.

In general, the filtration layer may comprise any suitable number of fiber webs (e.g., two fiber webs, three fiber webs, four fiber webs, five fiber webs, six or more fiber webs) that produce the gradient and/or pressure drop, described herein.

Regardless of the number of fiber webs in the filtration layer, the filter media may optionally comprise a second support layer, in addition to the first support layer, that helps holds the filtration layer in a waved configuration and maintains separation of peaks and troughs of adjacent waves of the filtration layer, as described further below. As illustrated in FIG. 1C, a filter media 90 may include a first support layer 95, an optional second support layer 100, and a filtration layer 105 comprising one or more fiber webs (e.g., 110, 115, and/or 120). The filtration layer 105 may be positioned between the first support layer 95 and optional second support layer 100. In some such embodiments, filtration layer 105 may be directly adjacent to the first and/or optional second support layer. In other such embodiments, one or more intervening fiber web or layer may be positioned between filtration layer 105 and first support layer 95 and/or optional second support layer 100. In certain embodiments, filtration layer 105 may include a coarse fiber web (e.g., 110) directly or indirectly adjacent to (e.g., upstream of) a fine fiber web (e.g., 120). In some embodiments, filtration layer 105 may include a fine fiber web (e.g., 120) directly or indirectly adjacent to (e.g., downstream of) a coarse fiber layer including a first coarse web (e.g., 110) and a second coarse fiber web (e.g., 115). In other embodiments, filtration layer 105 may include a single fiber web (e.g., 120).

In some embodiments, one or more fiber webs and/or layers in the filter media may be designed to be discrete from another fiber web and/or layer. That is, the fibers from one web and/or layer do not substantially intermingle (e.g., do not intermingle at all) with fibers from another fiber web and/or layer. For example, with respect to FIGS. 1A-1C, in one set of embodiments, fibers from the filtration layer do not substantially intermingle with fibers from the support layer. As another example, fibers from the fine fiber web do not substantially intermingle with fibers of a coarse fiber web. Discrete layers may be joined by any suitable process including, for example, by adhesives, as described in more detail below. It should be appreciated, however, that certain embodiments may include one or more layers that are not discrete with respect to one another.

It should be appreciated that the terms “first” and “second” webs, as used herein, refer to different webs within a layer and/or filter media, and are not meant to be limiting with respect to the location of that layer. Furthermore, in some embodiments, additional layers (e.g., “third”, “fourth”, or “fifth” webs) may be present in addition to the ones shown in the figures. It should also be appreciated that not all fiber webs or layers shown in the figures need be present in some embodiments.

As noted above, in some embodiments, a relationship may exist between fiber diameter and the thickness of the filtration layer, such that the gradient in fiber diameter may be characterized by two mathematical functions (e.g., convex function), as schematically illustrated in FIG. 2. FIG. 2 shows plots of a first mathematical function 130 and a second mathematical function 135 on a graph. The y-axis of the graph is average fiber diameter and the x-axis is the normalized thickness of the portion of the filtration layer having the gradient, such that zero corresponds to the top surface (e.g., most upstream) location of the gradient and one corresponds to the bottom surface (e.g., most downstream) location of the gradient. The first mathematical function may be different from the second mathematical function. In some such embodiments, the first mathematical function may have a greater average fiber diameter for any given normalized thickness compared to the second mathematical function. In such cases, the first mathematical function may serve as an upper limit for the average fiber diameter at a given normalized thickness. The second mathematical function may serve as the lower limit for the average fiber diameter at that normalized thickness.

Accordingly, in some embodiments, at least some of the average fiber diameters (e.g., all of the average fiber diameters) within the gradient may fall with the area 140 defined by the first and second mathematical functions. That is, in some embodiments, to produce a gradient, e.g., in fiber diameter that imparts beneficial properties (e.g., low pressure drop, long serve life) to the filter media, the average fiber diameter at certain locations (e.g., three or more locations, four or more locations, five or more locations, six or more locations, substantially all locations, all locations), along the thickness of the gradient must fall within area 140 defined by mathematical functions 130 and 135, as described in more detail below.

In some embodiments, the mathematical functions may be exponential functions. For instance, the first mathematical equation may have the form:

$$f ( x ) = \frac{{B}_{max}}{{( exp ( {A}_{min} * x ) )}^{2}}$$

wherein ƒ(x) is the average fiber diameter at x, x is the normalized thickness of the gradient, Bₘₐₓ is a constant with micron units, and Aₘᵢₙ is a constant. The average fiber diameter may be determined by using scanning electron microscopy (“SEM”) or X-ray computed tomography (“CT”) as described in more detail below. In some such embodiments, the second mathematical equation may have the form:

$$f ( x ) = \frac{{B}_{max}}{{( exp ( {A}_{min} * x ) )}^{2}}$$

wherein ƒ(x) is the average fiber diameter at x, x is the normalized thickness of the gradient, Bₘᵢₙ is a constant with micron units, and Aₘₐₓ is a constant. In some such embodiments, the average fiber diameter, ƒ(x), at one or more locations along thickness of the gradient may be determined using the mathematical expression:

$$\frac{{B}_{max}}{{( exp ( {A}_{min} * x ) )}^{2}} \leq f ( x ) \leq \frac{{B}_{max}}{{( exp ( {A}_{min} * x ) )}^{2}}$$

wherein ƒ(x) is the average fiber diameter at x, x is the normalized thickness of the gradient, Bₘₐₓ is a constant with micron units, Bₘᵢₙ is a constant with micron units, Aₘₐₓ is a constant, and Aₘᵢₙ is a constant. Thus, in some embodiments, the first mathematical function serves as an upper limit for the average fiber diameter at a given normalized thickness and the second mathematical function serves as a lower limit for the average fiber diameter at the same normalized thickness.

Without being bound by theory, it is believed that a gradient in fiber diameter having average fiber diameters that primarily fall above the first mathematical function produces a filtration layer that has a substantially diminished ability to trap particles and may not function as a depth filtration layer. Conversely, it is believed that a gradient in fiber diameters having average fiber diameters that primarily fall below the second mathematical function produces a filtration layer having a relatively high initial pressure drop and a filtration mechanism that is predominantly surface filtration, in which particles are primarily trapped on the upstream surface of the layer and, as a result, the filtration layer may have a relatively high initial pressure drop and increase in pressure drop during filtration. In some embodiments, a high pressure drop can reduce the service life of the filter media. Without being bound by theory, it is believed that the area between the two mathematical functions is predictive of the efficiency, filtration mechanism of the filtration layer (e.g. depth filtration, surface filtration), and pressure drop. The area between the two mathematical functions can be used to systemically design filter media having a desirable pressure drop, change in pressure drop over time, efficiency, and/or service life, amongst other beneficial properties.

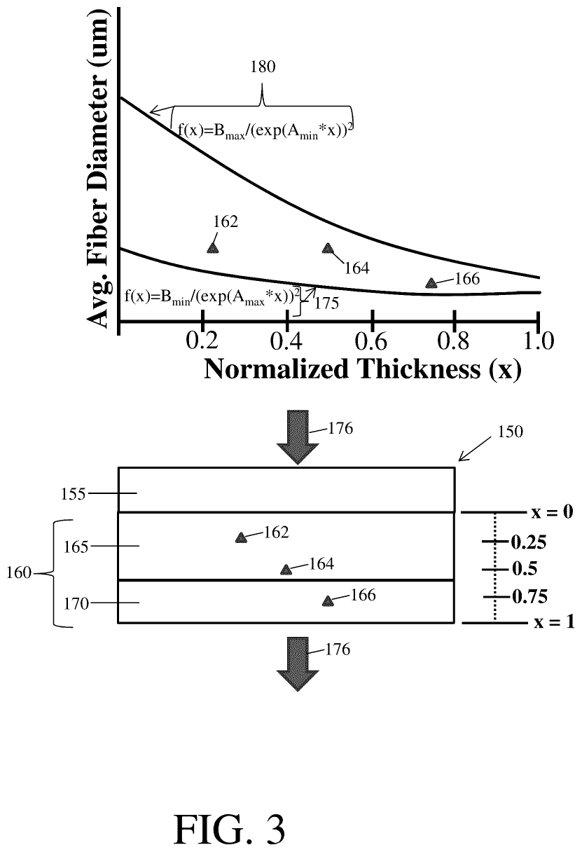

It should be understood that not all of the average fiber diameter along the thickness of the gradient must fall within the area between the two mathematical functions to produce a gradient that imparts beneficial properties to the filter media. In general, such a gradient may be produced when most (e.g., greater than or equal to about 60%, greater than or equal to about 70%, greater than or equal to about 75%, greater than or equal to about 80%, greater than or equal to about 90%, greater than or equal to about 95%) of the average fiber diameters along the thickness of the gradient fall within the area between the mathematical functions. Non-limiting examples of filter media including a support layer and a filtration layer having a gradient across at least a portion of the thickness of the filtration layer that imparts beneficial properties to the filter media are schematically illustrated in FIGS. 3-7. It should be understood that the mathematical equations shown in the figures are not to scale.

In one example, as illustrated in FIG. 3, a filter media 150 may comprise a support layer 155 and a filtration layer 160 comprising a coarse fiber web 165 positioned directly or indirectly adjacent to (e.g., upstream) of a fine fiber web 170. Coarse fiber web 165 (e.g., meltblown fiber web) and fine fiber web 170 (e.g., meltblown fiber web) may form a gradient, e.g., in fiber diameter. As illustrated in FIG. 3, filtration layer 160 may have average fiber diameters at three or more locations (e.g., 162, 164, 166) along the thickness of the filtration layer that are greater than or equal to the second mathematical function 175, described herein, and less than or equal to the first mathematical function 180 (e.g., exponential function), described herein. In some embodiments, filtration layer 160 may have an average fiber diameters at a normalized thickness of x is 0.25 (162), x is 0.5 (164), and x is 0.75 (166) that are greater than or equal to the second mathematical function 175 and less than or equal to the first mathematical function 180. Such a gradient in fiber diameter may allow the filtration layer to function as a depth filtration layer as fluid flows in the direction of arrows 176.

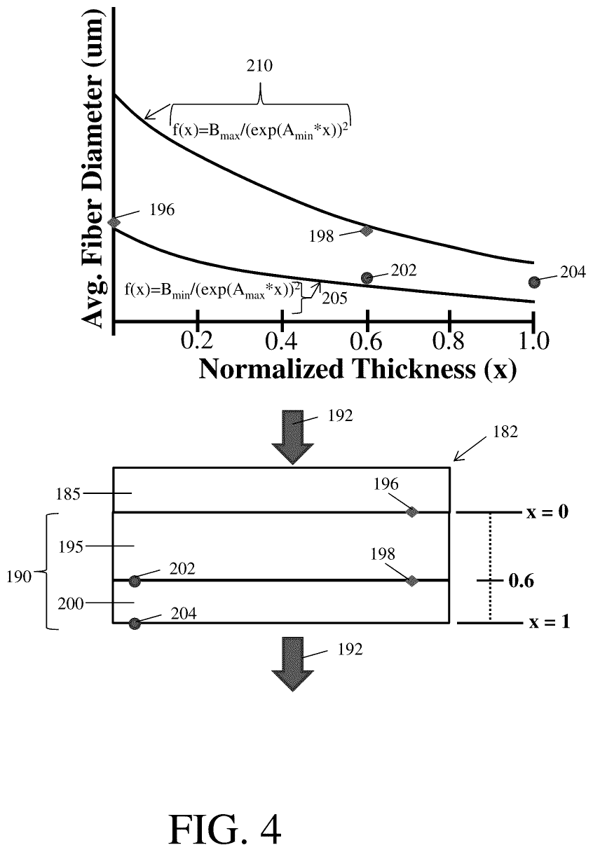

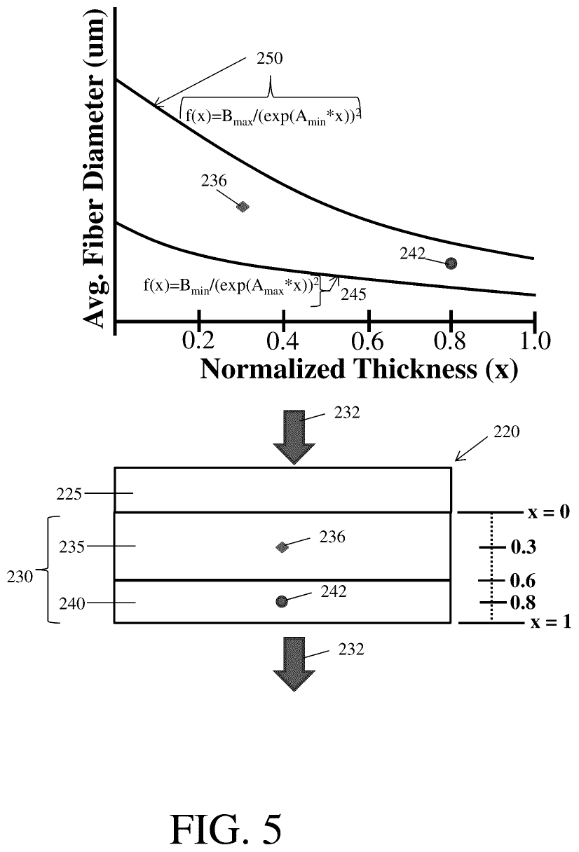

In another example, as illustrated in FIG. 4, a filter media 182 may comprise a support layer 185 and a filtration layer 190 comprising a coarse fiber web 195 positioned directly or indirectly adjacent to (e.g., upstream of) a fine fiber web 200. Coarse fiber web 195 (e.g., meltblown fiber web) and fine fiber web 200 (e.g., meltblown fiber web) may form a gradient, e.g., in fiber diameter. In some embodiments, each fiber web within the gradient may have an average fiber diameter at two or more locations along the thickness of the fiber web that are greater than or equal to the second mathematical function 205 (e.g., exponential function), described herein, and less than or equal to the first mathematical function 210 (e.g., exponential function), described herein. In certain embodiments, the two or more locations comprise the top surface (e.g., most upstream) location and the bottom surface (e.g., most downstream) location of a fiber web.

As illustrated in FIG. 4, coarse fiber web 195 may have average fiber diameter at two or more locations (e.g. 196, 198) along the thickness of the coarse fiber web that are greater than or equal to the second mathematical function 205 and less than or equal to the first mathematical function 210. In some such embodiments, the average fiber diameters at the top surface (e.g., most upstream) location (196) and the bottom surface (e.g., most downstream) location (198) of the coarse fiber web may be greater than or equal to the second mathematical function 205 and less than or equal to the first mathematical function 210. In some embodiments, fine fiber web 200 may also have average fiber diameters at two or more locations (e.g., 202, 204) along a thickness of the fine fiber web that are greater than or equal to the second mathematical function 205 and less than or equal to the first mathematical function 210. In some such embodiments, the average fiber diameters at the top surface (e.g., most upstream) location (202) and the bottom surface (e.g., most downstream) location (204) of the fine fiber web may be greater than or equal to the second mathematical function 205 and less than or equal to the first mathematical function 210. Such a gradient in fiber diameter may allow the filtration layer to function as a depth filtration layer as fluid flows in the direction of arrows 192.

In yet another example, as illustrated in FIG. 5, a filter media 220 may comprise a support layer 225 and a filtration layer 230 comprising a coarse fiber web 235 positioned directly or indirectly adjacent to (e.g., upstream of) a fine fiber web 240. Coarse fiber web 235 (e.g., meltblown fiber web) and fine fiber web 240 (e.g., meltblown fiber web) may form a gradient, e.g., in fiber diameter. In some embodiments, each fiber web within the gradient may have an average fiber diameter at one or more locations along the thickness of the fiber web that is greater than or equal to the second mathematical function 245 (e.g., exponential function), described herein, and less than or equal to the first mathematical function 250 (e.g., exponential function), described herein. In some embodiments, the one or more locations comprise the half thickness location of the fiber web.

As illustrated in FIG. 5, coarse fiber web 235 may have an average fiber diameter at one or more locations (e.g. 236) along the thickness of the coarse fiber web that is greater than or equal to the second mathematical function 245 and less than or equal to the first mathematical function 250. In some such embodiments, the average fiber diameter at the half thickness location (236) of the coarse fiber web may be greater than or equal to the second mathematical function 245 and less than or equal to the first mathematical function 250. In some such embodiments, fine fiber web 240 may have an average fiber diameter at one or more locations (e.g. 242) along the thickness of the fine fiber web that is greater than or equal to the second mathematical function 245 and less than or equal to the first mathematical function 250. In some such embodiments, the average fiber diameter at the half thickness location (242) of the fine fiber web may be greater than or equal to the second mathematical function 245 and less than or equal to the first mathematical function 250. Such a gradient in fiber diameter may allow the filtration layer to function as a depth filtration layer as fluid flows in the direction of arrows 232. As used herein, the “half thickness location” of a fiber web or layer has its ordinary meaning in the art and may refer to the location that is half way between the two opposing surfaces (e.g., top surface and bottom surface) that are used to ascertain the thickness of the fiber web or layer, respectively.

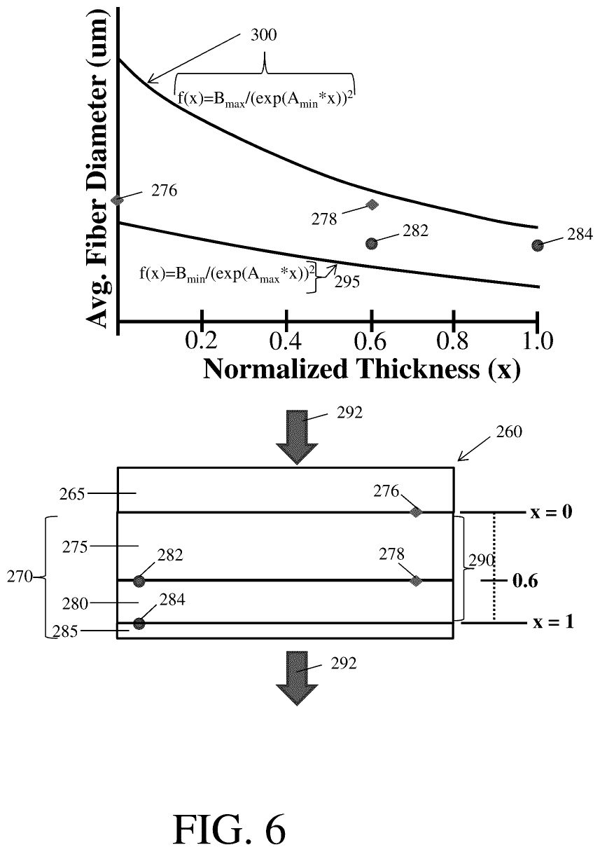

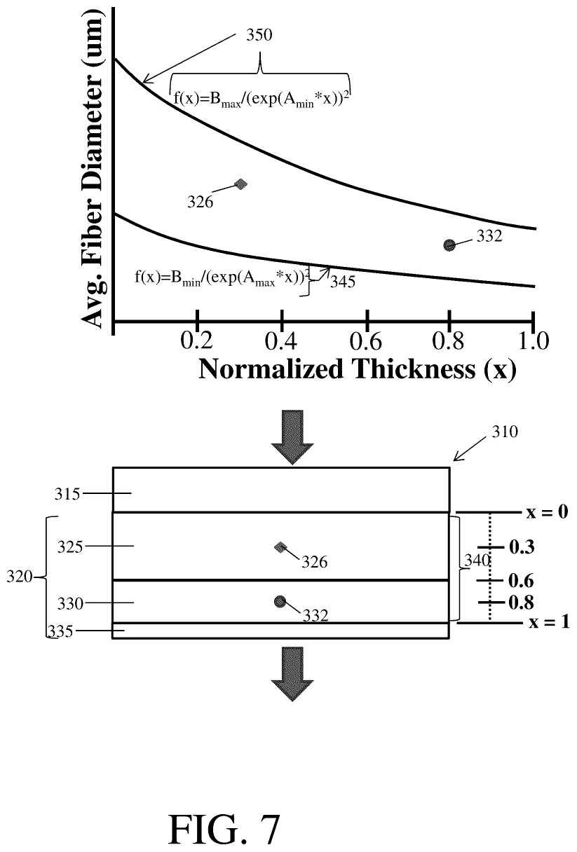

In some embodiments, a filtration layer may comprise a gradient across only a portion of the thickness of the filtration layer. Non-limiting examples of filter media including a support layer and a filtration layer having a gradient across a portion of the filtration layer that imparts beneficial properties are schematically illustrated in FIGS. 6-7.

In one example, as illustrated in FIG. 6, a filter media 260 may comprise a support layer 265 and a filtration layer 270 comprising a first coarse fiber web 275 (e.g., meltblown fiber web) and a second coarse fiber web 280 (e.g., meltblown fiber web) positioned directly or indirectly adjacent to (e.g., upstream) of a fine fiber web 285 (e.g., electrospun fiber web). In some embodiments, first coarse fiber web 275 and second coarse fiber web 280 may form a coarse fiber layer 290 having a gradient in fiber diameter. The gradient in coarse fiber layer 290 may be characterized by two mathematical functions (e.g., exponential functions), such that, e.g., the average fiber diameter at two or more locations along at least a portion of the thickness of coarse layer 290 falls within the area defined by the mathematical functions. In some embodiments, each fiber web within the gradient (e.g., coarse fiber layer) may have an average fiber diameter at two or more locations along the thickness of the fiber web that are greater than or equal to the second mathematical function 295 (e.g., exponential function), described herein, and less than or equal to the first mathematical function 300 (e.g., exponential function), described herein. In certain embodiments, the two or more locations comprise the top surface (e.g., most upstream) location and the bottom surface (e.g., most downstream) location of a fiber web.

As illustrated in FIG. 6, the first coarse fiber web 275 may have an average fiber diameter at two or more locations (e.g. 276, 278) along the thickness of the first coarse fiber web that are greater than or equal to the second mathematical function 295, described herein, and less than or equal to the first mathematical function 300. In some such embodiments, the average fiber diameters at the top surface (e.g., most upstream) location (276) and the bottom surface (e.g., most downstream) location (278) of the first coarse fiber web may be greater than or equal to the second mathematical function 295 and less than or equal to the first mathematical function 300. In some embodiments, the second coarse fiber web 280 may also have average fiber diameters at two or more locations (e.g., 282, 284) along a thickness of the second coarse fiber web that are greater than or equal to the second mathematical function 295 and less than or equal to the first mathematical function 300. In some such embodiments, the average fiber diameters at the top surface (e.g., most upstream) location (282) and the bottom surface (e.g., most downstream) location (284) of the second coarse fiber web may be greater than or equal to the second mathematical function 295 and less than or equal to the first mathematical function 300. Such a gradient in fiber diameter may allow the filtration layer to function as a depth filtration layer as fluid flows in the direction of arrows 292.

In another example, as illustrated in FIG. 7, a filter media 310 may comprise a support layer 315 and a filtration layer 320 comprising a first coarse fiber web 325 (e.g., meltblown fiber web) and a second coarse fiber web 330 (e.g., meltblown fiber web) positioned directly or indirectly adjacent to (e.g., upstream) of a fine fiber web 335 (e.g., electrospun fiber web). In some embodiments, first coarse fiber web 325 and second coarse fiber web 330 may form a coarse fiber layer 340 having a gradient in fiber diameter. The gradient in coarse fiber layer 340 may be characterized by two mathematical functions (e.g., exponential functions), such that, e.g., the average fiber diameter at two or more locations along at least a portion of the thickness of coarse layer 340 falls within the area defined by the mathematical functions. In some embodiments, each fiber web within the gradient may have an average fiber diameter at one or more locations along the thickness of the fiber web that is greater than or equal to the second mathematical function 345 (e.g., exponential function), described herein, and less than or equal to the first mathematical function 350 (e.g., exponential function), described herein. In some embodiments, the one or more locations comprise the half thickness location of the fiber web.

As illustrated in FIG. 7, the first coarse fiber web 325 may have an average fiber diameter at one or more locations (e.g. 326) along the thickness of the first coarse fiber web that is greater than or equal to the second mathematical function 345 and less than or equal to the first mathematical function 350. In some such embodiments, the average fiber diameter at the half thickness location (326) of the first coarse fiber web may be greater than or equal to the second mathematical function 345 and less than or equal to the first mathematical function 350. In some such embodiments, second coarse fiber web 330 may have an average fiber diameter at one or more locations (e.g. 332) along the thickness of the second coarse fiber web that is greater than or equal to the second mathematical function 345 and less than or equal to the first mathematical function 350. In some such embodiments, the average fiber diameter at the half thickness location (332) of the second coarse fiber web may be greater than or equal to the second mathematical function 345 and less than or equal to the first mathematical function 350. Such a gradient in fiber diameter may allow the filtration layer to function as a depth filtration layer as fluid flows in the direction of the arrows.

It should be understood that the two or more locations along the thickness of the gradient may be at any suitable normalized thickness. For instance, the two or more locations may be at x equals 0, about 0.05, about 0.1, about 0.15, about 0.2, about 0.25, about 0.3, about 0.35, about 0.4, about 0.45, about 0.5, about 0.55, about 0.6, about 0.65, about 0.7, about 0.75, about 0.8, about 0.85, about 0.9, about 0.95, and/or 1. Any suitable combinations of the above-referenced locations are possible (e.g., 0.25, 0.5, and 0.75). It should be also understood that the one or more locations along the thickness of a fiber web within the gradient may be at any suitable location. For instance, the one or more locations may be at the top surface, quarter thickness, half thickness, three-quarters thickness, and/or bottom surface locations. Any suitable combinations of the above-referenced locations are possible (e.g., top surface and bottom surface).

As used herein, the normalized thickness x refers to a dimensionless thickness that corresponds to a location along the thickness of the gradient. A normalized thickness value is calculated based on the thickness of the gradient. For example, referring to FIG. 2, a filtration layer 132 having a gradient may start at a depth of 2 mm within a filter media and end at a depth of 8 mm within the filter media. The normalized thickness value at a given location along the thickness of the filtration layer may be calculated by subtracting the top surface (e.g., most upstream) location of the filtration layer from the given location and dividing by the bottom surface (e.g., most downstream) location minus the top surface (e.g., most upstream) location of the filtration layer. For example, as illustrated in FIG. 2, the gradient portion may range from 2 mm to 8 mm. The thickness of the gradient is 6 mm. In such cases, the normalized thickness determined at a location of 5 mm is 0.5 (i.e., normalized thickness=(5−2)/(8−2)=0.5). As another example, in which the gradient portion may be isolated from the filter media, the normalized thickness at a given location may be calculated by dividing the given location by the thickness of the gradient portion. In general, the top surface (e.g., most upstream) location of the gradient is 0 and the bottom surface (e.g., most downstream) location of the gradient is 1.

In some embodiments, the constants Bₘₐₓ and Bₘᵢₙ may be related to certain structural properties of the filtration layer. In certain embodiments, Bₘₐₓ is related to the maximum suitable average fiber diameter at the top surface (e.g., most upstream) location (e.g., x=0) of the gradient portion of the filter media. In some embodiments, in which the gradient is along substantially all of the thickness of the filtration layer, the value of Bₘₐₓ may be greater than or equal to about 12 microns, greater than or equal to about 14 microns, greater than or equal to about 15 microns, greater than or equal to about 16 microns, greater than or equal to about 18 microns, greater than or equal to about 20 microns, greater than or equal to about 22 microns, greater than or equal to about 24 microns, greater than or equal to about 25 microns, greater than or equal to about 26 microns, or greater than or equal to about 28 microns. In some instances, the value of Bₘₐₓ may be less than or equal to about 30 microns, less than or equal to about 28 microns, less than or equal to about 26 microns, less than or equal to about 25 microns, less than or equal to about 24 microns, less than or equal to about 22 microns, less than or equal to about 20 microns, less than or equal to about 18 microns, less than or equal to about 16 microns, less than or equal to about 15 microns, or less than or equal to about 14 microns. Combinations of the above-referenced ranges are possible (e.g., greater than or equal to about 12 microns and less than or equal to about 30 microns, greater than or equal to about 12 microns and less than or equal to about 18 microns). In some embodiments, Bₘₐₓ is selected from the group consisting of about 12, about 12.5, about 13, about 13.5, about 14, about 14.5, about 15, about 15.5, about 16, about 16.5, about 17, about 17.5, about 18, about 18.5, about 19, about 19.5, about 20, about 20.5, about 21, about 21.5, about 22, about 22.5, about 23, about 23.5, about 24, about 24.5, about 25, about 25.5, about 26, about 26.5, about 27, about 27.5, about 28, about 28.5, about 29, about 29.5, and about 30. It should be understood that Bₘₐₓ may be any individual value within the above-referenced ranges. For example, Bₘₐₓ may be any individual value within the range greater than or equal to about 12 and less than or equal to about 30 (e.g., about 12, about 18, about 24, about 30). In certain embodiments, Bₘₐₓ is less than or equal to about 30 (e.g., less than or equal to about 18). In some such embodiments, Bₘₐₓ is greater than or equal to about 12.

In some embodiments, in which the gradient is along a portion (e.g., coarse fiber layer) of the thickness of the filtration layer, the value of Bₘₐₓ may be greater than or equal to about 5 microns, greater than or equal to about 6 microns, greater than or equal to about 7 microns, greater than or equal to about 8 microns, greater than or equal to about 9 microns, greater than or equal to about 10 microns, greater than or equal to about 11 microns, greater than or equal to about 12 microns, greater than or equal to about 13 microns, or greater than or equal to about 15 microns. In some instances, the value of Bₘₐₓ may be less than or equal to about 15 microns, less than or equal to about 14 microns, less than or equal to about 13 microns, less than or equal to about 12 microns, less than or equal to about 11 microns, less than or equal to about 10 microns, less than or equal to about 9 microns, less than or equal to about 8 microns, less than or equal to about 7 microns, or less than or equal to about 6 microns. Combinations of the above-referenced ranges are possible (e.g., greater than or equal to about 5 microns and less than or equal to about 15 microns, greater than or equal to about 5 microns and less than or equal to about 8 microns). In some embodiments, Bₘₐₓ is selected from the group consisting of about 5, about 5.5, about 6, about 6.5, about 7, about 7.5, about 8, about 8.5, about 9, about 9.5, about 10, about 10.5, about 11, about 11.5, about 12, about 12.5, about 13, about 13.5, about 14, about 14.5, and about 15. It should be understood that Bₘₐₓ may be any individual value within the above-referenced ranges. For example, Bₘₐₓ may be any individual value within the range greater than or equal to about 5 and less than or equal to about 15 (e.g., about 5, about 8, about 12, about 15). In certain embodiments, Bₘₐₓ is less than or equal to about 15 (e.g., less than or equal to about 8). In some such embodiments, Bₘₐₓ is greater than or equal to about 5.

Conversely, in certain embodiments, Bₘᵢₙ is related to the minimum suitable average fiber diameter at the top surface (e.g., most upstream) location (e.g., x=0) of the gradient portion of the filter media. In some embodiments, in which the gradient is along substantially all of the thickness of the filtration layer, the value of Bₘᵢₙ may be greater than or equal to about 1.5 microns, greater than or equal to about 1.6 microns, greater than or equal to about 1.8 microns, greater than or equal to about 2.0 microns, greater than or equal to about 2.2 microns, greater than or equal to about 2.4 microns, greater than or equal to about 2.5 microns, greater than or equal to about 2.6 microns, or greater than or equal to about 2.8 microns. In some instances, the value of Bₘᵢₙ may be less than or equal to about 3.0 microns, less than or equal to about 2.8 microns, less than or equal to about 2.6 microns, less than or equal to about 2.5 microns, less than or equal to about 2.4 microns, less than or equal to about 2.2 microns, less than or equal to about 2.0 microns, less than or equal to about 1.8 microns, or less than or equal to about 1.6 microns. Combinations of the above-referenced ranges are possible (e.g., greater than or equal to about 1.5 microns and less than or equal to about 3.0 microns, greater than or equal to about 2.5 microns and less than or equal to about 3.0 microns). In some embodiments, Bₘᵢₙ is selected from the group consisting of about 1.5, about 1.55, about 1.6, about 1.65, about 1.7, about 1.75, about 1.8, about 1.85, about 1.9, about 1.95, about 2, about 2.05, about 2.1, about 2.15, about 2.2, about 2.25, about 2.3, about 2.35, about 2.4, about 2.45, about 2.5, about 2.55, about 2.6, about 2.65, about 2.7, about 2.75, about 2.8, about 2.85, about 2.9, about 2.95, and about 3. It should be understood that Bₘᵢₙ may be any individual value within the above-referenced ranges. For example, Bₘᵢₙ may be any individual value within the range greater than about 1.5 and less than or equal to about 3 (e.g., about 1.5, about 2, about 2.5, about 3.0). In certain embodiments, Bₘᵢₙ is greater than or equal to about 1.5 (e.g., greater than or equal to about 2.5). In some such embodiments, Bₘᵢₙ is less than or equal to about 3.0.

In some embodiments, in which the gradient is along a portion (e.g., coarse fiber layer) of the thickness of the filtration layer, the value of Bₘᵢₙ may be greater than or equal to about 1.0 micron, greater than or equal to about 1.1 microns, greater than or equal to about 1.2 microns, greater than or equal to about 1.3 micron, greater than or equal to about 1.4 microns, greater than or equal to about 1.5 microns, greater than or equal to about 1.6 microns, greater than or equal to about 1.7 microns, greater than or equal to about 1.8 microns, or greater than or equal to about 1.9 microns. In some instances, the value of Bₘᵢₙ may be less than or equal to about 2.0 microns, less than or equal to about 1.9 microns, less than or equal to about 1.8 microns, less than or equal to about 1.7 microns, less than or equal to about 1.6 microns, less than or equal to about 1.5 microns, less than or equal to about 1.4 microns, less than or equal to about 1.3 microns, less than or equal to about 1.2 microns, or less than or equal to about 1.1 microns. Combinations of the above-referenced ranges are possible (e.g., greater than or equal to about 1.0 micron and less than or equal to about 2.0 microns, greater than or equal to about 1.3 microns and less than or equal to about 2.0 microns). In some embodiments, Bₘᵢₙ is selected from the group consisting of about 1.0, about 1.05, about 1.1, about 1.15, about 1.2, about 1.25, about 1.3, about 1.35, about 1.4, about 1.45, about 1.5, about 1.55, about 1.6, about 1.65, about 1.7, about 1.75, about 1.8, about 1.85, about 1.9, about 1.95, and about 2. It should be understood that Bₘᵢₙ may be any individual value within the above-referenced ranges. For example, Bₘᵢₙ may be any individual value within the range greater than about 1.0 and less than or equal to about 2.0 (e.g., about 1.0, about 1.3, about 1.5, about 1.8, about 2.0). In certain embodiments, Bₘᵢₙ is greater than or equal to about 1.0 (e.g., greater than or equal to about 1.3). In some such embodiments, Bₘᵢₙ is less than or equal to about 2.0.

In some embodiments, the constants Aₘₐₓ and Aₘᵢₙ may be related to the change in average fiber diameter across the gradient portion of the filter media. Without being bound by theory, it is believed that a gradual decrease in average fiber diameter as described by parameter A contributes to the attainment of a depth loading filtration mechanism and prevents surface loading. In certain embodiments, Aₘₐₓ is related to the maximum change in average fiber diameter that prevents dust cake formation, and accordingly surface filtration, on the downstream portion of the filter media. In some embodiments, Aₘᵢₙ is related to the minimum change in average fiber diameter across the gradient portion of the filter media in which a depth filtration mechanism, and not surface filtration, dominates on the upstream portion of the filter media. Aₘᵢₙ equals zero corresponds to a filter media without a gradient portion.

In certain embodiments, gradients in fiber diameter characterized by exponential functions with certain values of Aₘₐₓ and Aₘᵢₙ may have enhanced filtration properties (e.g., low initial pressure drop, low increase in pressure drop over time) compared to filter lacking a gradient or filter media having a gradient characterized by exponential functions with other values of Aₘₐₓ and Aₘᵢₙ. For instance, in some embodiments, in which the gradient is along substantially all of the thickness of the filtration layer, enhanced filtration properties may be achieved with values of Aₘₐₓ greater than or equal to about 1.4, greater than or equal to about 1.45, greater than or equal to about 1.5, greater than or equal to about 1.55, greater than or equal to about 1.6, greater than or equal to about 1.65, or greater than or equal to about 1.7. In some instances, enhanced filtration properties may be achieved with values of Aₘₐₓ less than or equal to 1.75, less than or equal to about 1.7, less than or equal to about 1.65, less than or equal to about 1.6, less than or equal to about 1.55, less than or equal to about 1.5, or less than or equal to about 1.45. Combinations of the above-referenced ranges are possible (e.g., greater than or equal to about 1.4 and less than or equal to about 1.7, greater than or equal to about 1.4 and less than or equal to about 1.5). In some embodiments, Aₘₐₓ is selected from the group consisting of about 1.4, about 1.41, about 1.42, about 1.43, about 1.44, about 1.45, about 1.46, about 1.47, about 1.48, about 1.49, about 1.5, about 1.51, about 1.52, about 1.53, about 1.54, about 1.55, about 1.56, about 1.57, about 1.58, about 1.59, about 1.6, about 1.61, about 1.62, about 1.63, about 1.64, about 1.65, about 1.66, about 1.67, about 1.68, about 1.69, and about 1.7. It should be understood that Aₘₐₓ may be any individual value within the above-referenced ranges. For example, Aₘₐₓ may be any individual value within the range greater than or equal to about 1.4 and less than or equal to about 1.7 (e.g., about 1.7, about 1.6, about 1.5, about 1.4). In certain embodiments, Aₘₐₓ is less than or equal to about 1.7 (e.g., less than or equal to about 1.5). In some such embodiments, Aₘₐₓ is greater than or equal to about 1.4.

In some embodiments, in which the gradient is along a portion (e.g., coarse fiber layer) of the thickness of the filtration layer, enhanced filtration properties may be achieved with values of Aₘₐₓ greater than or equal to about 0.7, greater than or equal to about 0.75, greater than or equal to about 0.8, greater than or equal to about 0.85, greater than or equal to about 0.9, greater than or equal to about 0.95, greater than or equal to about 1.0, greater than or equal to about 1.1, greater than or equal to about 1.2, greater than or equal to about 1.3, or greater than or equal to about 1.4. In some instances, enhanced filtration properties may be achieved with values of Aₘₐₓ less than or equal to 1.5, less than or equal to about 1.4, less than or equal to about 1.3, less than or equal to about 1.2, less than or equal to about 1.1, less than or equal to about 1.0, less than or equal to about 0.95, less than or equal to about 0.9, less than or equal to about 0.85, less than or equal to about 0.8, or less than or equal to about 0.75. Combinations of the above-referenced ranges are possible (e.g., greater than or equal to about 0.7 and less than or equal to about 1.5, greater than or equal to about 0.7 and less than or equal to about 0.8). In some embodiments, Aₘₐₓ is 0.7. In some embodiments, Aₘₐₓ is selected from the group consisting of about 0.7, about 0.71, about 0.72, about 0.73, about 0.74, about 0.75, about 0.76, about 0.77, about 0.78, about 0.79, about 0.8, about 0.81, about 0.82, about 0.83, about 0.84, about 0.85, about 0.86, about 0.87, about 0.88, about 0.89, about 0.9, about 0.91, about 0.92, about 0.93, about 0.94, about 0.95, about 0.96, about 0.97, about 0.98, about 0.99, about 1, about 1.01, about 1.02, about 1.03, about 1.04, about 1.05, about 1.06, about 1.07, about 1.08, about 1.09, about 1.1, about 1.11, about 1.12, about 1.13, about 1.14, about 1.15, about 1.16, about 1.17, about 1.18, about 1.19, about 1.2, about 1.21, about 1.22, about 1.23, about 1.24, about 1.25, about 1.26, about 1.27, about 1.28, about 1.29, about 1.3, about 1.31, about 1.32, about 1.33, about 1.34, about 1.35, about 1.36, about 1.37, about 1.38, about 1.39, about 1.4, about 1.41, about 1.42, about 1.43, about 1.44, about 1.45, about 1.46, about 1.47, about 1.48, about 1.49, and about 1.5. It should be understood that Aₘₐₓ may be any individual value within the above-referenced ranges. For example, Aₘₐₓ may be any individual value within the range greater than or equal to about 0.7 and less than or equal to about 1.5 (e.g., about 1.5, about 1.25, about 1, about 0.8. about 0.7). In certain embodiments, Aₘₐₓ is less than or equal to about 1.5 (e.g., less than or equal to about 0.8). In some such embodiments, Aₘₐₓ is greater than or equal to about 0.7.

In some embodiments, in which the gradient is along substantially all of the thickness of the filtration layer, enhanced filtration properties may be achieved with values of Aₘᵢₙ greater than about 0, greater than or equal to about 0.1, greater than or equal to about 0.2, greater than or equal to about 0.3, greater than or equal to about 0.4, greater than or equal to about 0.5, greater than or equal to about 0.6, greater than or equal to about 0.7, greater than or equal to about 0.8, greater than or equal to about 0.9, greater than or equal to about 1.0, or greater than or equal to about 1.1. In some instances, enhanced filtration properties may be achieved with values of Aₘᵢₙ less than or equal to 1.2, less than or equal to about 1.1, less than or equal to about 1.0, less than or equal to about 0.9, less than or equal to about 0.8, less than or equal to about 0.7, less than or equal to about 0.6, less than or equal to about 0.5, less than or equal to about 0.4, less than or equal to about 0.3, less than or equal to about 0.2, or less than or equal to about 0.1. Combinations of the above-referenced ranges are possible (e.g., greater than about 0 and less than or equal to about 1.2, greater than or equal to about 1.1 and less than or equal to about 1.2). In some embodiments, Aₘᵢₙ is selected from the group consisting of about 0.01, about 0.02, about 0.03, about 0.04, about 0.05, about 0.06, about 0.07, about 0.08, about 0.09, about 0.1, about 0.11, about 0.12, about 0.13, about 0.14, about 0.15, about 0.16, about 0.17, about 0.18, about 0.19, about 0.2, about 0.21, about 0.22, about 0.23, about 0.24, about 0.25, about 0.26, about 0.27, about 0.28, about 0.29, about 0.3, about 0.31, about 0.32, about 0.33, about 0.34, about 0.35, about 0.36, about 0.37, about 0.38, about 0.39, about 0.4, about 0.41, about 0.42, about 0.43, about 0.44, about 0.45, about 0.46, about 0.47, about 0.48, about 0.49, about 0.5, about 0.51, about 0.52, about 0.53, about 0.54, about 0.55, about 0.56, about 0.57, about 0.58, about 0.59, about 0.6, about 0.61, about 0.62, about 0.63, about 0.64, about 0.65, about 0.66, about 0.67, about 0.68, about 0.69, about 0.7, about 0.71, about 0.72, about 0.73, about 0.74, about 0.75, about 0.76, about 0.77, about 0.78, about 0.79, about 0.8, about 0.81, about 0.82, about 0.83, about 0.84, about 0.85, about 0.86, about 0.87, about 0.88, about 0.89, about 0.9, about 0.91, about 0.92, about 0.93, about 0.94, about 0.95, about 0.96, about 0.97, about 0.98, about 0.99, about 1, about 1.01, about 1.02, about 1.03, about 1.04, about 1.05, about 1.06, about 1.07, about 1.08, about 1.09, about 1.1, about 1.11, about 1.12, about 1.13, about 1.14, about 1.15, about 1.16, about 1.17, about 1.18, about 1.19, and about 1.2. It should be understood that Aₘᵢₙ may be any individual value within the above-referenced ranges. For example, Aₘᵢₙ may be any individual value within the range greater than about 0 and less than or equal to about 1.2 (e.g., about 0.1, about 0.5, about 0.8, about 1.1, about 1.2). In certain embodiments, Aₘᵢₙ is greater than about 0 (e.g., greater than or equal to about 1.1). In some such embodiments, Aₘᵢₙ is less than or equal to about 1.2.

In some embodiments, in which the gradient is along a portion (e.g., coarse fiber layer) of the thickness of the filtration layer, enhanced filtration properties may be achieved with values of Aₘᵢₙ greater than about 0, greater than or equal to about 0.05, greater than or equal to about 0.1, greater than or equal to about 0.15, greater than or equal to about 0.2, greater than or equal to about 0.25, greater than or equal to about 0.3, or greater than or equal to about 0.35. In some instances, enhanced filtration properties may be achieved with values of Aₘᵢₙ less than or equal to 0.4, less than or equal to about 0.35, less than or equal to about 0.3, less than or equal to about 0.25, less than or equal to about 0.2, less than or equal to about 0.15, less than or equal to about 0.1, or less than or equal to about 0.05. Combinations of the above-referenced ranges are possible (e.g., greater than about 0 and less than or equal to about 0.4, greater than or equal to about 0.3 and less than or equal to about 0.4). In some embodiments, Aₘᵢₙ is selected from the group consisting of about 0.01, about 0.02, about 0.03, about 0.04, about 0.05, about 0.06, about 0.07, about 0.08, about 0.09, about 0.1, about 0.11, about 0.12, about 0.13, about 0.14, about 0.15, about 0.16, about 0.17, about 0.18, about 0.19, about 0.2, about 0.21, about 0.22, about 0.23, about 0.24, about 0.25, about 0.26, about 0.27, about 0.28, about 0.29, about 0.3, about 0.31, about 0.32, about 0.33, about 0.34, about 0.35, about 0.36, about 0.37, about 0.38, about 0.39, and about 0.4. It should be understood that Aₘᵢₙ may be any individual value within the above-referenced ranges. For example, Aₘᵢₙ may be any individual value within the range greater than about 0 and less than or equal to about 0.4 (e.g., about 0.1, about 0.2, about 0.3, about 0.4). In certain embodiments, Aₘᵢₙ is greater than about 0 (e.g., greater than or equal to about 0.3). In some such embodiments, Aₘᵢₙ is less than or equal to about 0.4.

In general, the average fiber diameter, ƒ(x), at a specific location within the filtration layer may be determined using any technique known to those of ordinary skill in the art to produce accurate measurements of average fiber diameter. For instance, the average fiber diameter at one or more surfaces (e.g., top surface and/or bottom surface, the most upstream and/or most downstream location) of a fiber web or the filtration layer may be determined using scanning electron microscopy (SEM). In some embodiments, the average fiber diameter at a location may be determined my measuring fiber diameters using a scanning electron microscope SEM at a working distance of 13.6 mm-22.9 mm, with a magnification ranging between 20×-30×. The filter media or filtration layer may be vacuum sputter coated with gold prior to image acquisition.

In some embodiments, the average fiber diameter within a fiber web or the filtration layer may be determined using X-ray computed tomography using suitable instrumentation (e.g., ZEISS Xradia 810 Ultra x-ray nano-tomograph manufactured by Carl Zeiss Microscopy GmbH 07745 Jena, Germany). In general, X-ray computed tomography is used to produce a 3D computational representation of the filter media. Computational methods are used to distinguish void spaces (i.e., pores) from solid regions (i.e., fibers) of the filter. Additional computational methods may then be used to determine the average diameter of the solid regions (i.e., fiber) of the 3D computational representation of the filter media. In some instances, the computational method establishes a cut-off value (i.e., threshold value) for distinguishing voids from solid regions to generate the 3D computational representation of the filter media. In such cases, the accuracy of the cut-off value may be confirmed by comparing the computationally determined air permeability of the 3D computational representation of the filter media to the experimentally determined air permeability of the actual filter media. In embodiments in which the computationally and experimentally determined air permeabilities are substantially different, the threshold value may be changed by the user until the air permeabilities are substantially the same.

For instance, in embodiments in which the diameter of the discrete fibers changes across at least a portion of the thickness of the filter media, an X-ray computed tomography (“CT”) machine may scan the filter media and take a plurality of X-ray radiographs at various projection angles through the filter media. Each X-ray radiograph may depict a slice along a plane of the filter media and is converted into a grayscale image of the slice by computational methods known to those of skill in the art (e.g., ZEISS Xradia 810 Ultra x-ray nano-tomograph manufactured by Carl Zeiss Microscopy GmbH 07745 Jena, Germany). Each slice has a defined thickness such that the grayscale image of the slice is composed of voxels (volume elements), not pixels (picture elements). The plurality of slices generated from the X-ray radiographs may be used to produce a 3D volume rendering of the entire filter media thickness with cross-sectional dimensions of at least 100×100 μm using computational methods as noted above. The resolution (voxel size) of the image may be less than or equal to 0.3 microns.

In some embodiments, the 3D volume rendering of the entire filter media thickness along with experimental measurements of the permeability of the filter media may be used to determine the average fiber diameter. Each individual grayscale image generated from the X-ray radiographs typically consists of light intensity data scaled in an 8-bit range (i.e., 0-255 possible values). To form the 3D volume rendering of the entire filter media thickness, the 8-bit grayscale images are converted into binary images. The conversion of the 8-bit grayscale images to binary images requires the selection of an appropriate intensity threshold cut-off value to distinguish solid regions of the filter media from pore spaces in the filter media. The intensity threshold cut-off value is applied to the 8-bit grayscale image and is used to correctly segment solid and pore spaces in the binary image. The binary images are then used to create a virtual media domain, i.e., 3D rectangular array of filled (fiber) voxels and void (pore) voxels that accurately identifies solid regions and pore spaces. Various thresholding algorithms are reviewed in: Jain, A. (1989), Fundamentals of digital image processing, Englewood Cliffs, NJ: Prentice Hall. and Russ. (2002), The image processing handbook, 4th ed. Boca Raton, Fla: CRC Press.

The intensity threshold cut-off value may be selected based on comparison of the computationally determined air permeability of the virtual media domain in the transverse direction (i.e., the direction along the thickness) and experimentally determined air permeability of the entire filter media thickness in the transverse direction. In some such embodiments, the experimental air permeability of the entire filter media thickness may be determined according to TAPPI T-251, e.g., using a Textest FX 3300 air permeability tester III (Textest AG, Zurich), a sample area of 38 cm², and a pressure drop of 0.5 inches of water to obtain the Frasier permeability value of the entire filter media thickness in CFM. The Frasier permeability value in CFM is further converted to transverse media permeability in SI units according to the following conversion equation where to is thickness of the sample.

$$K [ in {m}^{2} ] = 7.47 e - 10 * CFM [ in feet / min or CFM / {ft}^{2} ] * {t}_{0} [ in m ] \qquad ( 2 )$$

The air permeability of the virtual media domain in the transverse direction may be computed using the computational fluid dynamics (CFD) solution of Navier-Stokes equation. A virtual media domain is generated by preselecting an intensity threshold cut-off value and converting the grayscale images into a virtual domain media using the preselected intensity threshold cut-off value. Once, the virtual media domain is generated, numerical analysis can be performed directly on the virtual media domain using computational methods know to those of ordinary skill in the art. For example, GeoDict 2010R2 software package can be used to directly convert grayscale images into the virtual media domain and to efficiently solve Stoke's equation,

$$- μ ∇ ∇ u + ∇ p = 0 , ∇ u = 0 , \qquad ( 3 )$$

with no slip boundary conditions in the pore space (see, e.g., Wiegmann, 2001-2010 GEODICT virtual micro structure simulator and material property predictor.). The domain averaging of the resulting velocity field in transverse direction together with Darcy's equation,

$$< u >= - k ∇ p / μ , \qquad ( 4 )$$

allows determination of transverse air permeability k of virtual media.

The computational air permeability in the transverse direction is then compared to the experimental air permeability in the transverse direction. In embodiments in which the computational air permeability is substantially the same (e.g., a difference of 5% or less) as the experimental air permeability, then the virtual media domain generated using the preselected intensity threshold cut-off value is used to determine average fiber diameter. In embodiments in which the computational air permeability is different than the experimental air permeability, the intensity threshold cut-off value is changed until the computational air permeability is substantially the same as the experimental air permeability. The mean pore size of the virtual media domain that has substantially the same computational air permeability as the experimental air permeability can then be used to determine the average fiber diameter using any method known to those of ordinary skill in the art (e.g., PoroDict module of the GeoDict software package).

It should be understood that though a filtration layer having a gradient in a property has been described in terms of a gradient in average fiber diameter, the filtration layer may have a gradient in another property (e.g., mean flow pore size, solidity) instead of, or in addition to, a gradient in average fiber diameter. For instance, in some embodiments, a filtration layer having a gradient in average fiber diameter across at least a portion of the thickness of the filtration layer may have a gradient in mean flow pore size and/or a gradient in solidity. In general, the filtration layer may have a gradient in any property or combinations of properties that are capable of achieving the desired filtration properties.

As described herein, a filtration layer may have a gradient in average fiber diameter across at least a portion of the thickness of the filtration layer. In some embodiments, the gradient in average fiber diameter may be across the entire filtration layer. In some such embodiments, the filtration layer may be a single fiber web or have multiple fiber webs that form the gradient. In other embodiments, the gradient in average fiber diameter may be across a portion of the filtration layer. In some such cases, the portion of the filtration layer having the gradient in average fiber diameter may be a portion of a single fiber web, or at least one fiber web of a multi-layered filter media. In some instances, the portion of the filtration layer having the gradient in average fiber diameter may be across one or more fiber webs of a multi-web filtration layer. For instance, the gradient may be across the thickness of 1, 2, 3, 4, 5, 6, etc. fiber webs of a multi-web filtration layer. In some such embodiments, each fiber web of a multi-web gradient may have a different average fiber diameter. The change in fiber diameter across the multiple webs may be characterized by two mathematical functions, as described herein. In certain embodiments, at least one fiber web (e.g., each fiber web) of a multi-web gradient may have a constant average fiber diameter, i.e., the average fiber diameter does not substantially change across the thickness of the fiber web. For example, a multi-web gradient may comprise two or more fiber webs (e.g., laminated together) that each has a substantially constant mean pore size across the thickness of the fiber web and each has a different average fiber diameter than the other fiber webs.

In some embodiments, the gradient in average fiber diameter may be across at least a portion of the thickness of the filtration layer or the entire thickness of the filtration layer. For instance, in some embodiments, the gradient in average fiber diameter may be across greater than or equal to about 10%, greater than or equal to about 20%, greater than equal to about 30%, greater than or equal to about 40%, greater than or equal to about 50%, greater than or equal to about 60%, greater than equal to about 70%, greater than or equal to about 80%, or greater than or equal to about 90% of the thickness of the filtration layer. In some instances, the gradient in average fiber diameter may be across less than or equal to about 100%, less than or equal to about 99%, less than or equal to about 97%, less than or equal to about 95%, less than equal to about 90%, less than or equal to about 80%, less than or equal to about 70%, less than or equal to about 60%, less than or equal to about 50%, less than or equal to about 40%, less than or equal to about 30%, less than or equal to about 20%, or less than or equal to about 10% of the thickness of the filtration layer. Combinations of the above-referenced ranges are possible (e.g., greater than or equal to about 10% and less than or equal to about 100%, greater than or equal to about 40% and less than or equal to about 100%). Other values are possible. The percentage of the total thickness of the filtration layer occupied by the gradient in average fiber diameter may be determined by dividing the thickness of the gradient portion by the thickness of the filtration layer.

In some embodiments, a single or multiple web gradient may be formed by a variance in one or more characteristics of the layer(s). In certain embodiments, a fiber characteristic and/or structural property may be varied across a single web or multiple webs to form a gradient in average fiber diameter. For example, the weight percentage of two or more fibers having different fiber diameters may be varied across a single web or multiple webs to form a gradient. In some embodiments, one or more layers and/or fiber webs that do not include a gradient in average fiber diameter (i.e., non-gradient layer or web) in the filter media may impart structural and mechanical support to the overall filter media and may contribute to the overall structural or performance characteristics of the filter media. In some such cases, the one or more non-gradient layers may not substantially alter the filtration properties of the filter media.

In certain embodiments, one or more non-gradient layer(s) in the filtration layer or filter media may contribute to the overall filtration properties of the filter media. For instance, one or more non-gradient layer(s) (e.g., fine fiber web) may be an efficiency layer having a relatively small average fiber diameter that is included in the filter media to improve the overall efficiency. In one example, an efficiency layer (e.g., fine fiber web) may be positioned directly or indirectly adjacent to (e.g., downstream of) a filtration layer having a gradient in average fiber diameter. In some such embodiments, the gradient may be adjacent to the efficiency layer. In general, the one or more non-gradient layer(s) may be selected as desired for a given application. A filter media may comprise a non-gradient efficiency layer and a non-gradient pre-filter. In general, a multi-layered filter media having one or more gradient layer(s) may include any suitable type or number of non-gradient layers.

It should be understood that the planar configurations of at least some of the webs and layers (e.g., all of the fiber webs and layers) shown in the figures are for ease of illustration only. In general, the filter media, described herein, comprises a filtration layer that is held in a waved or curvilinear configuration by one or more support layers. In some embodiments, the waved configuration of the filtration layer may increase the surface area of the filtration layer relative to a planar filtration layer having a similar length, resulting in improved filtration properties, such as efficiency and pressure drop. In addition to the waved filtration layer and support layer, the filter media may comprise one or more optional layers or fiber webs. The one or more optional layers or fiber webs may be any suitable layer (e.g., a cover layer, a support layer) and may be waved or planar.

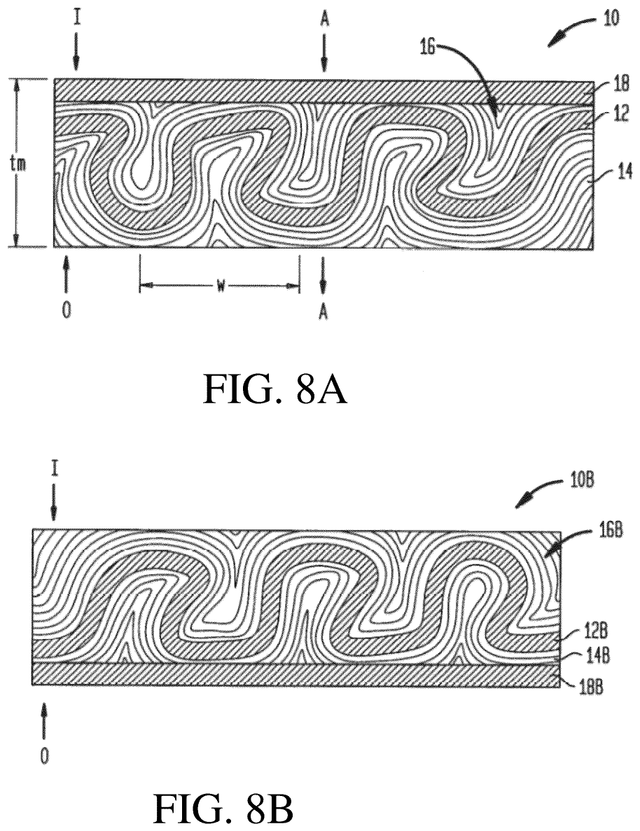

A non-limiting example of the waved configuration of a filter media comprising a filtration layer and a support layer that holds the filtration layer in a waved configuration to maintain separation of peaks and troughs of adjacent waves of the filtration layer is shown in FIG. 8A. As shown in FIG. 8A, a filter media 10 may include a filtration layer 12 positioned between a first support layer 16 and an optional second support layer 14. Though two support layers (e.g., 14 and 16) are shown, it should be understood that the filter media 10 need not include both support layers. Where only one support layer is provided, the support layer can be disposed on a top or bottom surface (e.g., upstream or downstream) of the filtration layer. The one or more support layers (e.g., 14, 16) can help maintain filtration layer 12, and optionally any additional layers or fiber webs in the waved configuration, as described further below.

As described herein, in some embodiments, filter media 10 may also include one or more optional layers. For instance, filter media 10 may optionally include one or more cover layers located on the top (e.g., upstream-most) and/or bottom (e.g., downstream-most) sides of the filter media 10. As shown in FIG. 8A, filter media 10 may include a cover layer 18 positioned on the top (e.g., most upstream) side of filter media. In certain embodiments, cover layer 18 may serve as an aesthetic layer or an abrasion resistance layer. In some such embodiments, filter media may be configured, as shown in FIG. 8A, such that cover layer 18 is positioned on the fluid (e.g., air) entering side of the filter media, labeled I, support layer 16 is positioned directly or indirectly adjacent to (e.g., downstream of) cover layer 18, filtration layer 12 is positioned directly or indirectly adjacent to (e.g., downstream of) support layer 16, and optional second support layer 14 is positioned directly or indirectly adjacent to (e.g., downstream) of filtration layer 12 on the fluid (e.g., air) outflow side, labeled O. The direction of fluid (e.g., air) flow, i.e., from fluid entering I to fluid outflow O, is indicated by the arrows marked with reference A.

In certain embodiments, as illustrated in FIG. 8B, a filter media 10B may include an optional cover layer 18B positioned on the fluid (e.g., air) exiting side of the filter media, labeled I, in addition to or as an alternative to optional cover layer 18 in FIG. 8A. In some such embodiments, optional cover layer 18B is positioned directly or indirectly adjacent to (e.g., downstream of) an optional support layer 14 is positioned directly or indirectly adjacent to (e.g., upstream of) optional cover layer 18B, a filtration layer 12B is positioned directly or indirectly adjacent to (e.g., upstream of) optional support layer 14B, a support layer 16B is positioned directly or indirectly adjacent to (e.g., upstream of) filtration layer 12B. In some embodiments, cover layer 18B may serve as a strengthening component that provides structural integrity to the filter media 10 to help maintain the waved configuration or offer abrasion resistance.

In some embodiments, as shown in FIGS. 8A and 8B, the optional cover layer(s) may have a topography that is different than the topographies of the filtration layer and/or the support layer(s). For instance, regardless of whether the filter media is in a pleated or non-pleated configuration, the cover layer(s) may be non-waved (e.g., substantially planar), whereas the filtration layer and/or the support layer(s) may have a waved configuration.

As described in more detail below, the filtration layer may comprise synthetic fibers, amongst other fiber types. In some instances, the filtration layer may comprise a relatively high weight percentage of synthetic fibers (e.g., greater than or equal to about 95 wt. %, 100 wt. %). In some instances, the synthetic fibers may be continuous (e.g., greater than about 5 cm, greater than about 50 cm, greater than about 200 cm), as described further below. In certain embodiments, the fine fiber web may comprise a relatively high percentage (e.g., greater than or equal to about 95 wt. %, 100 wt. %) of synthetic fibers formed via an electrospinning or meltblowing process. In certain embodiments, one or more coarse fiber webs (e.g., first coarse fiber web, second coarse fiber web) may comprise a relatively high percentage (e.g., greater than or equal to about 95 wt. %, 100 wt. %) of synthetic fibers formed via a meltblowing process. In general, the filtration layer (e.g., fine fiber web, one or more coarse fiber webs) may comprise synthetic fibers formed by any suitable process including an electrospinning process, meltblowing process, melt spinning process, or centrifugal spinning process.

In general, any fiber web in the filtration layer, and accordingly the filter media, may include any suitable fiber type. In some embodiments, one or more fiber webs (e.g., fine fiber web, coarse fiber web, first coarse fiber web, second coarse fiber web), the filtration layer, and/or the entire filter media may include a single fiber type (e.g., synthetic fibers). For example, in certain embodiments, one or more fiber webs, the filtration layer, and/or the entire filter media may include synthetic fibers. Synthetic fibers may include any suitable type of synthetic polymer. Examples of suitable synthetic fibers include polyimide, aliphatic polyamide (e.g., nylon 6), aromatic polyamide, polysulfone, cellulose acetate, polyether sulfone, polyaryl ether sulfone, modified polysulfone polymers, modified polyethersulfone polymers, polymethyl methacrylate, polyacrylonitrile, polyurethane, poly(urea urethane), polybenzimidazole, polyetherimide, polyacrylonitrile, poly(ethylene terephthalate), polypropylene, silicon dioxide (silica), regenerated cellulose (e.g., Lyocell, rayon,) carbon (e.g., derived from the pyrolysis of polyacrilonitrile), polyaniline, poly(ethylene oxide), poly(ethylene naphthalate), poly(butylene terephthalate), styrene butadiene rubber, polystyrene, poly(vinyl chloride), poly(vinyl alcohol), poly(vinylidene fluoride), poly(vinyl butylene) and copolymers or derivative compounds thereof, and combinations thereof. In some embodiments, the synthetic fibers are organic polymer fibers. Synthetic fibers may also include multi-component fibers (i.e., fibers having multiple compositions such as bicomponent fibers). In some cases, synthetic fibers may include electrospun (e.g., melt, solvent), meltblown, meltspun, or centrifugal spun fibers, which may be formed of polymers described herein (e.g., polyester, polypropylene). In some embodiments, synthetic fibers may be electrospun fibers. In some embodiments, synthetic fibers may be meltblown fibers. The filter media, as well as each of the fiber webs within the filter media, may also include combinations of more than one type of synthetic fiber. It should be understood that other types of synthetic fiber types may also be used. In some embodiments, the fine fiber web may comprise fibers having a relatively small average fiber diameter (e.g., greater than or equal to about 0.02 microns and less than or equal to about 0.3 microns) and/or one or more coarse fiber webs (e.g., first coarse fiber web, second coarse fiber web) comprises fibers having a relatively large fiber diameter (e.g., greater than or equal to about 0.1 microns and less than or equal to about 30 microns).

In some embodiments, one or more fiber webs (e.g., fine fiber web, coarse fiber web, first coarse fiber web, second coarse fiber web), the filtration layer, and/or the entire filter media may include fiberglass fibers.

In one set of embodiments, the fibers (e.g., electrospun fibers) in the fine fiber web may have an average fiber diameter of greater than or equal to about 0.02 microns, greater than or equal to about 0.04 microns, greater than or equal to about 0.05 microns, greater than or equal to about 0.06 microns, greater than or equal to about 0.08 microns, greater than or equal to about 0.1 microns, greater than or equal to about 0.12 microns, greater than or equal to about 0.14 microns, greater than or equal to about 0.15 microns, greater than or equal to about 0.16 microns, greater than or equal to about 0.18 microns, greater than or equal to about 0.2 microns, greater than or equal to about 0.22 microns, greater than or equal to about 0.24 microns, greater than or equal to about 0.26 microns, or greater than or equal to about 0.28 microns. In some instances, the fibers may have an average diameter of less than or equal to about 0.3 microns, less than or equal to about 0.28 microns, less than or equal to about 0.26 microns, less than or equal to about 0.24 microns, less than or equal to about 0.22 microns, less than or equal to about 0.2 microns, less than or equal to about 0.18 microns, less than or equal to about 0.16 microns, less than or equal to about 0.15, microns, less than or equal to about 0.14 microns, less than or equal to about 0.12 microns, less than or equal to about 0.1 microns, less than or equal to about 0.08 microns, or less than or equal to about 0.06 microns. Combinations of the above-referenced ranges are also possible (e.g., greater than or equal to about 0.02 microns and less than or equal to about 0.3 microns, greater than or equal to about 0.05 microns and less than or equal to about 0.15 microns).

In some such embodiments, the fibers (e.g., meltblown fibers) in one or more coarse fiber webs and/or the coarse fiber layer may have an average fiber diameter of greater than or equal to about 0.1 microns, greater than or equal to about 0.2 microns, greater than or equal to about 0.5 microns, greater than or equal to about 1 micron, greater than or equal to about 2 microns, greater than or equal to about 5 microns, greater than or equal to about 8 microns, greater than or equal to about 10 microns, greater than or equal to about 12 microns, greater than or equal to about 14 microns, greater than or equal to about 15 microns, greater than or equal to about 16 microns, greater than or equal to about 18 microns, greater than or equal to about 20 microns, greater than or equal to about 22 microns, greater than or equal to about 24 microns, greater than or equal to about 26 microns, or greater than or equal to about 28 microns. In some instances, the fibers may have an average diameter of less than or equal to about 30 microns, less than or equal to about 28 microns, less than or equal to about 26 microns, less than or equal to about 24 microns, less than or equal to about 22 microns, less than or equal to about 20 microns, less than or equal to about 18 microns, less than or equal to about 16 microns, less than or equal to about 15, microns, less than or equal to about 14 microns, less than or equal to about 12 microns, less than or equal to about 10 microns, less than or equal to about 8 microns, less than or equal to about 6 microns, less than or equal to about 5 microns, less than or equal to about 2 microns, or less than or equal to about 1 micron. Combinations of the above-referenced ranges are also possible (e.g., greater than or equal to about 0.1 microns and less than or equal to about 30 microns, greater than or equal to about 0.2 microns and less than or equal to about 15 microns).

In another embodiment, the fine fiber web may comprise fibers having a relatively small average fiber diameter (e.g., greater than or equal to about 0.1 microns and less than or equal to about 15 microns) and/or one or more coarse fiber webs (e.g., coarse fiber web, first coarse fiber web, second coarse fiber web) comprises fibers having a relatively large fiber diameter (e.g., greater than or equal to about 0.5 microns and less than or equal to about 25 microns). In another set of embodiments, the fibers (e.g., meltblown fibers) in the fine fiber web may have an average fiber diameter of greater than or equal to about 0.1 microns, greater than or equal to about 0.2 microns, greater than or equal to about 0.5 microns, greater than or equal to about 1 micron, greater than or equal to about 2 microns, greater than or equal to about 4 microns, greater than or equal to about 6 microns, greater than or equal to about 8 microns, greater than or equal to about 10 microns, greater than or equal to about 12 microns, or greater than or equal to about 14 microns. In some instances, the fibers may have an average diameter of less than or equal to about 15 microns, less than or equal to about 14 microns, less than or equal to about 12 microns, less than or equal to about 10 microns, less than or equal to about 8 microns, less than or equal to about 6 microns, less than or equal to about 5 microns, less than or equal to about 4 microns, less than or equal to about 2 microns, less than or equal to about 1 micron, less than or equal to about 0.8 microns, or less than or equal to about 0.5 microns. Combinations of the above-referenced ranges are also possible (e.g., greater than or equal to about 0.1 microns and less than or equal to about 15 microns, greater than or equal to about 0.2 microns and less than or equal to about 8 microns).

In some such embodiments, the fibers (e.g., meltblown fibers) in one or more coarse fiber webs may have an average fiber diameter of greater than or equal to about 0.5 microns, greater than or equal to about 1 micron, greater than or equal to about 2 microns, greater than or equal to about 4 microns, greater than or equal to about 5 microns, greater than or equal to about 6 microns, greater than or equal to about 8 microns, greater than or equal to about 10 microns, greater than or equal to about 12 microns, greater than or equal to about 14 microns, greater than or equal to about 15 microns, greater than or equal to about 16 microns, greater than or equal to about 18 microns, greater than or equal to about 20 microns, greater than or equal to about 22 microns, or greater than or equal to about 24 microns. In some instances, the fibers may have an average diameter of less than or equal to about 25 microns, less than or equal to about 24 microns, less than or equal to about 22 microns, less than or equal to about 20 microns, less than or equal to about 18 microns, less than or equal to about 16 microns, less than or equal to about 15 microns, less than or equal to about 14 microns, less than or equal to about 12 microns, less than or equal to about 10 microns, less than or equal to about 8 microns, less than or equal to about 6 microns, less than or equal to about 4 microns, less than or equal to about 2 microns, or less than or equal to about 1 micron. Combinations of the above-referenced ranges are also possible (e.g., greater than or equal to about 0.5 microns and less than or equal to about 25 microns, greater than or equal to about 2 microns and less than or equal to about 15 microns).

In some embodiments, the fibers in one or more fiber webs, the filtration layer, and/or the entire filter media 15 may be continuous fibers formed by any suitable process (e.g., a melt-blown, a meltspun, an electrospinning, centrifugal spinning process). In certain embodiments, at least some of the synthetic fibers may be formed by an electrospinning process (e.g., melt electrospinning, solvent electrospinning). In other embodiments, the synthetic fibers may be non-continuous. In some embodiments, all of the fibers in the filter media are synthetic fibers. In certain embodiments, all of the fibers in the filtration layer are synthetic fibers.

In some cases, the synthetic fibers (e.g., in the first and/or second coarse fiber webs, fine fiber webs) may be continuous (e.g., electrospun fibers, meltblown fibers, spunbond fibers, centrifugal spun fibers, etc.). For instance, synthetic fibers may have an average length of at least about 5 cm, at least about 10 cm, at least about 15 cm, at least about 20 cm, at least about 50 cm, at least about 100 cm, at least about 200 cm, at least about 500 cm, at least about 700 cm, at least about 1000 cm, at least about 1500 cm, at least about 2000 cm, at least about 2500 cm, at least about 5000 cm, at least about 10000 cm; and/or less than or equal to about 10000 cm, less than or equal to about 5000 cm, less than or equal to about 2500 cm, less than or equal to about 2000 cm, less than or equal to about 1000 cm, less than or equal to about 500 cm, or less than or equal to about 200 cm. Combinations of the above-referenced ranges are also possible (e.g., greater than or equal to about 100 cm and less than or equal to about 2500 cm). Other values of average fiber length are also possible.

In other embodiments, the synthetic fibers are not continuous (e.g., staple fibers). In general, synthetic non-continuous fibers may be characterized as being shorter than continuous synthetic fibers. For instance, in some embodiments, synthetic fibers in one or more fiber webs (e.g., second fiber web) in the filter media may have an average length of at least about 0.1 mm, at least about 0.5 mm, at least about 1.0 mm, at least about 1.5 mm, at least about 2.0 mm, at least about 3.0 mm, at least about 4.0 mm, at least about 5.0 mm, at least about 6.0 mm, at least about 7.0 mm, at least about 8.0 mm, at least about 9.0 mm, at least about 10.0 mm, at least about 12.0 mm, at least about 15.0 mm, and/or less than or equal to about 15.0 mm, less than or equal to about 12.0 mm, less than or equal to about 10.0 mm, less than or equal to about 5.0 mm, less than or equal to about 4.0 mm, less than or equal to about 1.0 mm, less than or equal to about 0.5 mm, or less than or equal to about 0.1 mm. Combinations of the above-referenced ranges are also possible (e.g., at least about 1.0 mm and less than or equal to about 4.0 mm). Other values of average fiber length are also possible.

In some embodiments in which synthetic fibers are included in one or more fiber webs, one or more layers (e.g., filtration layer, coarse fiber layer), and/or the entire filter media, the weight percentage of synthetic fibers in one or more fiber webs (e.g., fine fiber web, coarse fiber web, first coarse fiber web, second coarse fiber web), one or more layers (e.g., filtration layer, coarse fiber layer), and/or the entire filter media may be greater than or equal to about 50%, greater than or equal to about 60%, greater than or equal to about 75%, greater than or equal to about 90%, greater than or equal to about 95%, greater than or equal to about 98%, or greater than or equal to about 99%. In some instances, the weight percentage of synthetic fibers may be less than or equal to about 100%, less than or equal to about 99%, less than or equal to about 98%, less than or equal to about 95%, less than or equal to about 90%, less than or equal to about 80%, or less than or equal to about 70%. Combinations of the above-referenced ranges are also possible (e.g., greater than or equal to about 75% and less than or equal to about 100%). In some embodiments, one or more fiber webs (e.g., fine fiber web, coarse fiber web, first coarse fiber web, second coarse fiber web), one or more layers (e.g., filtration layer, coarse fiber layer), and/or the entire filter media includes 100% synthetic fibers.

In some embodiments, the filtration layer may be relatively thin. For instance, in some embodiments, the filtration layer in a planar configuration (e.g., prior to waving) may have a thickness of greater than or equal to about 1 mil, greater than or equal to about 2 mil, greater than or equal to about 4 mil, greater than or equal to about 5 mil, greater than or equal to about 6 mil, greater than or equal to about 8 mil, greater than or equal to about 10 mil, greater than or equal to about 12 mil, greater than or equal to about 14 mil, greater than or equal to about 16 mil, or greater than or equal to about 18 mil. In some instances, the filtration layer may have a thickness of less than or equal to about 20 mil, less than or equal to about 17 mil, less than or equal to about 15 mil, less than or equal to about 14 mil, less than or equal to about 12 mil, less than or equal to about 10 mil, less than or equal to about 8 mil, less than or equal to about 6 mil, less than or equal to about 4 mil, or less than or equal to about 2 mil. Combinations of the above-referenced ranges are also possible (e.g., greater than or equal to about 1 mil and less than or equal to about 20 mil, greater than or equal to about 5 mil and less than or equal to about 17 mil, greater than or equal to about 1 mil and less than or equal to about 15 mil, greater than or equal to about 2 mil and less than or equal to about 6 mil). The thickness may be determined according to the standard ASTM D1777 at 2.6 psi.

In some embodiments, one or more coarse fiber webs (e.g., meltblown fiber web) of the filtration layer may be relatively thin. For instance, in some embodiments, the one or more coarse fiber webs in a planar configuration (e.g., prior to waving) may have a thickness of greater than or equal to about 1 mil, greater than or equal to about 2 mil, greater than or equal to about 3 mil, greater than or equal to about 5 mil, greater than or equal to about 6 mil, greater than or equal to about 8 mil, greater than or equal to about 10 mil, greater than or equal to about 12 mil, or greater than or equal to about 14 mil. In some instances, one or more coarse fiber webs may have a thickness of less than or equal to about 15 mil, less than or equal to about 14 mil, less than or equal to about 12 mil, less than or equal to about 10 mil, less than or equal to about 8 mil, less than or equal to about 7 mil, less than or equal to about 6 mil, less than or equal to about 4 mil, or less than or equal to about 2 mil. Combinations of the above-referenced ranges are also possible (e.g., greater than or equal to about 1 mil and less than or equal to about 15 mil, greater than or equal to about 2 mil and less than or equal to about 15 mil, greater than or equal to about 3 mil and less than or equal to about 10 mil). The thickness may be determined according to the standard ASTM D1777 at 2.6 psi.

In some embodiments, the fine fiber web (e.g., electrospun fiber web, meltblown fiber web) in a planar configuration (e.g., prior to waving) may have a thickness of greater than or equal to about 0.1 mil, greater than or equal to about 0.2 mil, greater than or equal to about 0.5 mil, greater than or equal to about 0.8 mil, greater than or equal to about 1 mil, greater than or equal to about 2 mil, greater than or equal to about 3 mil, greater than or equal to about 5 mil, greater than or equal to about 6 mil, greater than or equal to about 8 mil, greater than or equal to about 10 mil, greater than or equal to about 12 mil, or greater than or equal to about 14 mil. In some instances, the fine fiber web may have a thickness of less than or equal to about 15 mil, less than or equal to about 14 mil, less than or equal to about 12 mil, less than or equal to about 10 mil, less than or equal to about 8 mil, less than or equal to about 7 mil, less than or equal to about 6 mil, less than or equal to about 5 mil, less than or equal to about 4 mil, less than or equal to about 3 mil, less than or equal to about 2 mil, less than or equal to about 1 mil, or less than or equal to about 0.5 mil. Combinations of the above-referenced ranges are also possible (e.g., greater than or equal to about 0.1 mil and less than or equal to about 15 mil, greater than or equal to about 0.1 mil and less than or equal to about 5 mil, greater than or equal to about 1 mil and less than or equal to about 7 mil, greater than or equal to about 3 mil and less than or equal to about 7 mil). The thickness may be determined using scanning electron microscopy (SEM) to image a cross-section of the fiber web.

In one embodiment, the filtration layer may comprise a fine fiber web (e.g., electrospun fiber web) having a relatively small basis weight (e.g., greater than or equal to about 0.01 g/m² and less than or equal to about 3 g/m²) and one or more coarse fiber webs (e.g., meltblown fiber webs) having a relatively small basis weight (e.g., greater than or equal to about 2 g/m² and less than or equal to about 30 g/m²). In some such embodiments, the filtration layer may have a basis weight of greater than or equal to about 2 g/m², greater than or equal to about 4 g/m², greater than or equal to about 5 g/m², greater than or equal to about 6 g/m², greater than or equal to about 8 g/m², greater than or equal to about 10 g/m², greater than or equal to about 12 g/m², greater than or equal to about 14 g/m², greater than or equal to about 16 g/m², greater than or equal to about 18 g/m², greater than or equal to about 20 g/m², greater than or equal to about 22 g/m², greater than or equal to about 24 g/m², greater than or equal to about 26 g/m², or greater than or equal to about 28 g/m². In some instances, the filtration layer may have a basis weight of less than or equal to about 30 g/m², less than or equal to about 28 g/m², less than or equal to about 26 g/m², less than or equal to about 24 g/m², less than or equal to about 22 g/m², less than or equal to about 20 g/m², less than or equal to about 18 g/m², less than or equal to about 16 g/m², less than or equal to about 15 g/m², less than or equal to about 14 g/m², less than or equal to about 12 g/m², less than or equal to about 10 g/m², less than or equal to about 8 g/m², or less than or equal to about 6 g/m². Combinations of the above-referenced ranges are also possible (e.g., greater than or equal to about 2 g/m² and less than or equal to about 30 g/m², greater than or equal to about 5 g/m² and less than or equal to about 20 g/m²). The basis weight may be determined according to the standard ASTM D-846.

In some such embodiments, one or more coarse fiber webs (e.g., meltblown fiber webs) may have a basis weight of greater than or equal to about 2 g/m², greater than or equal to about 4 g/m², greater than or equal to about 5 g/m², greater than or equal to about 6 g/m², greater than or equal to about 8 g/m², greater than or equal to about 10 g/m², greater than or equal to about 12 g/m², greater than or equal to about 14 g/m², greater than or equal to about 16 g/m², greater than or equal to about 18 g/m², greater than or equal to about 20 g/m², greater than or equal to about 22 g/m², greater than or equal to about 24 g/m², greater than or equal to about 26 g/m², or greater than or equal to about 28 g/m². In some instances, one or more coarse fiber webs (e.g., meltblown fiber webs) may have a basis weight of less than or equal to about 30 g/m², less than or equal to about 28 g/m², less than or equal to about 26 g/m², less than or equal to about 24 g/m², less than or equal to about 22 g/m², less than or equal to about 20 g/m², less than or equal to about 18 g/m², less than or equal to about 16 g/m², less than or equal to about 15 g/m², less than or equal to about 14 g/m², less than or equal to about 12 g/m², less than or equal to about 10 g/m², less than or equal to about 8 g/m², or less than or equal to about 6 g/m². Combinations of the above-referenced ranges are also possible (e.g., greater than or equal to about 2 g/m² and less than or equal to about 30 g/m², greater than or equal to about 5 g/m² and less than or equal to about 20 g/m²). The basis weight may be determined according to the standard ASTM D-846.

In some such cases, the fine fiber web (e.g., electrospun web) may have a basis weight of greater than or equal to about 0.01 g/m², greater than or equal to about 0.05 g/m², greater than or equal to about 0.1 g/m², greater than or equal to about 0.2 g/m², greater than or equal to about 0.4 g/m², greater than or equal to about 0.6 g/m², greater than or equal to about 0.8 g/m², greater than or equal to about 1.0 g/m², greater than or equal to about 1.2 g/m², greater than or equal to about 1.4 g/m², greater than or equal to about 1.6 g/m², greater than or equal to about 1.8 g/m², greater than or equal to about 2.0 g/m², greater than or equal to about 2.2 g/m², greater than or equal to about 2.4 g/m², greater than or equal to about 2.6 g/m², or greater than or equal to about 2.8 g/m². In some instances, the fine fiber web (e.g., electrospun fiber web) may have a basis weight of less than or equal to about 3.0 g/m², less than or equal to about 2.8 g/m², less than or equal to about 2.6 g/m², less than or equal to about 2.4 g/m², less than or equal to about 2.2 g/m², less than or equal to about 2.0 g/m², less than or equal to about 1.8 g/m², less than or equal to about 1.6 g/m², less than or equal to about 1.5 g/m², less than or equal to about 1.4 g/m², less than or equal to about 1.2 g/m², less than or equal to about 1.0 g/m², less than or equal to about 0.8 g/m², less than or equal to about 0.6 g/m², less than or equal to about 0.4 g/m², less than or equal to about 0.2 g/m², or less than or equal to about 0.1 g/m². Combinations of the above-referenced ranges are also possible (e.g., greater than or equal to about 0.01 g/m² and less than or equal to about 3.0 g/m², greater than or equal to about 0.05 g/m² and less than or equal to about 0.8 g/m²). The basis weight may be determined according to the standard ASTM D-846.

In another embodiment, the filtration layer may comprise a fine fiber web (e.g., meltblown fiber web) having a relatively small basis weight (e.g., greater than or equal to about 2 g/m² and less than or equal to about 30 g/m²) and one or more coarse fiber webs (e.g., meltblown fiber webs) having a relatively small basis weight (e.g., greater than or equal to about 4 g/m² and less than or equal to about 40 g/m²). In some such embodiments, the filtration layer may have a basis weight of greater than or equal to about 4 g/m², greater than or equal to about 5 g/m², greater than or equal to about 6 g/m², greater than or equal to about 8 g/m², greater than or equal to about 10 g/m², greater than or equal to about 12 g/m², greater than or equal to about 14 g/m², greater than or equal to about 16 g/m², greater than or equal to about 18 g/m², greater than or equal to about 20 g/m², greater than or equal to about 22 g/m², greater than or equal to about 24 g/m², greater than or equal to about 25 g/m², greater than or equal to about 27 g/m², greater than or equal to about 30 g/m², greater than or equal to about 32 g/m², greater than or equal to about 34 g/m², greater than or equal to about 36 g/m², or greater than or equal to about 38 g/m². In some instances, the filtration layer may have a basis weight of less than or equal to about 40 g/m², less than or equal to about 38 g/m², less than or equal to about 36 g/m², less than or equal to about 34 g/m², less than or equal to about 32 g/m², less than or equal to about 30 g/m², less than or equal to about 28 g/m², less than or equal to about 26 g/m², less than or equal to about 25 g/m², less than or equal to about 24 g/m², less than or equal to about 22 g/m², less than or equal to about 20 g/m², less than or equal to about 18 g/m², less than or equal to about 15 g/m², less than or equal to about 12 g/m², less than or equal to about 10 g/m², or less than or equal to about 6 g/m². Combinations of the above-referenced ranges are also possible (e.g., greater than or equal to about 4 g/m² and less than or equal to about 40 g/m², greater than or equal to about 10 g/m² and less than or equal to about 25 g/m²). The basis weight may be determined according to the standard ASTM D-846.

In some such embodiments, one or more coarse fiber webs may have a basis weight of greater than or equal to about 3 g/m², greater than or equal to about 5 g/m², greater than or equal to about 6 g/m², greater than or equal to about 8 g/m², greater than or equal to about 10 g/m², greater than or equal to about 12 g/m², greater than or equal to about 14 g/m², greater than or equal to about 16 g/m², greater than or equal to about 18 g/m², greater than or equal to about 20 g/m², greater than or equal to about 22 g/m², greater than or equal to about 24 g/m², greater than or equal to about 25 g/m², greater than or equal to about 27 g/m², greater than or equal to about 30 g/m², greater than or equal to about 32 g/m², greater than or equal to about 34 g/m², greater than or equal to about 36 g/m², or greater than or equal to about 38 g/m². In some instances, one or more coarse fiber webs may have a basis weight of less than or equal to about 40 g/m², less than or equal to about 38 g/m², less than or equal to about 36 g/m², less than or equal to about 34 g/m², less than or equal to about 32 g/m², less than or equal to about 30 g/m², less than or equal to about 28 g/m², less than or equal to about 26 g/m², less than or equal to about 25 g/m², less than or equal to about 24 g/m², less than or equal to about 22 g/m², less than or equal to about 20 g/m², less than or equal to about 18 g/m², less than or equal to about 15 g/m², less than or equal to about 12 g/m², less than or equal to about 10 g/m², or less than or equal to about 6 g/m². Combinations of the above-referenced ranges are also possible (e.g., greater than or equal to about 3 g/m² and less than or equal to about 40 g/m², greater than or equal to about 5 g/m² and less than or equal to about 30 g/m²). The basis weight may be determined according to the standard ASTM D-846.

In some such cases, the fine fiber webs (e.g., meltblown fiber web) may have a basis weight of greater than or equal to about 2 g/m², greater than or equal to about 4 g/m², greater than or equal to about 5 g/m², greater than or equal to about 6 g/m², greater than or equal to about 8 g/m², greater than or equal to about 10 g/m², greater than or equal to about 12 g/m², greater than or equal to about 14 g/m², greater than or equal to about 16 g/m², greater than or equal to about 18 g/m², greater than or equal to about 20 g/m², greater than or equal to about 22 g/m², greater than or equal to about 24 g/m², greater than or equal to about 26 g/m², or greater than or equal to about 28 g/m². In some instances, the fine fiber web (e.g., meltblown fiber webs) may have a basis weight of less than or equal to about 30 g/m², less than or equal to about 28 g/m², less than or equal to about 26 g/m², less than or equal to about 24 g/m², less than or equal to about 22 g/m², less than or equal to about 20 g/m², less than or equal to about 18 g/m², less than or equal to about 16 g/m², less than or equal to about 15 g/m², less than or equal to about 14 g/m², less than or equal to about 12 g/m², less than or equal to about 10 g/m², less than or equal to about 8 g/m², or less than or equal to about 6 g/m². Combinations of the above-referenced ranges are also possible (e.g., greater than or equal to about 2 g/m² and less than or equal to about 30 g/m², greater than or equal to about 4 g/m² and less than or equal to about 20 g/m²). The basis weight may be determined according to the standard ASTM D-846.

In one embodiment, the filtration layer comprising a fine fiber web and one or more coarse fiber webs may have any suitable mean flow pore size. In one example, the mean flow pore size of the filtration layer may be greater than or equal to about 2 microns, greater than or equal to about 5 microns, greater than or equal to about 8 microns, greater than or equal to about 10 microns, greater than or equal to about 12 microns, greater than or equal to about 15 microns, greater than or equal to about 18 microns, greater than or equal to about 20 microns, greater than or equal to about 22 microns, greater than or equal to about 25 microns, greater than or equal to about 28 microns, greater than or equal to about 30 microns, greater than or equal to about 32 microns, or greater than or equal to about 35 microns. In some instances, the filtration layer may have a mean flow pore size of less than or equal to about 40 microns, less than or equal to about 38 microns, less than or equal to about 35 microns, less than or equal to about 32 microns, less than or equal to about 30 microns, less than or equal to about 28 microns, less than or equal to about 25 microns, less than or equal to about 22 microns, less than or equal to about 20 microns, less than or equal to about 18 microns, less than or equal to about 15 microns, less than or equal to about 12 microns, less than or equal to about 10 microns, less than or equal to about 8 microns, or less than or equal to about 5 microns. Combinations of the above-referenced ranges are also possible (e.g., greater than or equal to about 2 microns and less than or equal to about 40 microns, greater than or equal to about 5 microns and less than or equal to about 25 microns). The mean flow pore size may be determined according to the standard ASTM F316-03.

The mean flow pore size of the fine fiber web (e.g., electrospun web) may be greater than or equal to about 2 microns, greater than or equal to about 5 microns, greater than or equal to about 8 microns, greater than or equal to about 10 microns, greater than or equal to about 12 microns, greater than or equal to about 15 microns, greater than or equal to about 18 microns, greater than or equal to about 20 microns, greater than or equal to about 22 microns, greater than or equal to about 25 microns, or greater than or equal to about 28 microns. In some instances, the fine fiber web (e.g., electrospun web) may have a mean flow pore size of less than or equal to about 30 microns, less than or equal to about 28 microns, less than or equal to about 25 microns, less than or equal to about 22 microns, less than or equal to about 20 microns, less than or equal to about 28 microns, less than or equal to about 25 microns, less than or equal to about 22 microns, less than or equal to about 20 microns, less than or equal to about 18 microns, less than or equal to about 15 microns, less than or equal to about 12 microns, less than or equal to about 10 microns, less than or equal to about 8 microns, or less than or equal to about 5 microns. Combinations of the above-referenced ranges are also possible (e.g., greater than or equal to about 2 microns and less than or equal to about 30 microns, greater than or equal to about 5 microns and less than or equal to about 20 microns). The mean flow pore size may be determined according to the standard ASTM F316-03.

The mean flow pore size of one or more coarse fiber webs (e.g., meltblown fiber web) may be greater than or equal to about 5 microns, greater than or equal to about 7 microns, greater than or equal to about 10 microns, greater than or equal to about 12 microns, greater than or equal to about 15 microns, greater than or equal to about 18 microns, greater than or equal to about 20 microns, greater than or equal to about 22 microns, greater than or equal to about 25 microns, greater than or equal to about 28 microns, greater than or equal to about 30 microns, greater than or equal to about 32 microns, or greater than or equal to about 35 microns. In some instances, one or more coarse fiber webs may have a mean flow pore size of less than or equal to about 40 microns, less than or equal to about 38 microns, less than or equal to about 35 microns, less than or equal to about 32 microns, less than or equal to about 30 microns, less than or equal to about 28 microns, less than or equal to about 25 microns, less than or equal to about 22 microns, less than or equal to about 20 microns, less than or equal to about 18 microns, less than or equal to about 15 microns, less than or equal to about 12 microns, less than or equal to about microns, less than or equal to about 8 microns, or less than or equal to about 5 micron. Combinations of the above-referenced ranges are also possible (e.g., greater than or equal to about 5 microns and less than or equal to about 40 microns, greater than or equal to about 7 microns and less than or equal to about 25 microns). The mean flow pore size may be determined according to the standard ASTM F316-03.

In another embodiment, the mean flow pore size of the filtration layer may be greater than or equal to about 5 microns, greater than or equal to about 8 microns, greater than or equal to about 10 microns, greater than or equal to about 12 microns, greater than or equal to about 15 microns, greater than or equal to about 18 microns, greater than or equal to about 20 microns, greater than or equal to about 22 microns, greater than or equal to about 25 microns, greater than or equal to about 28 microns, greater than or equal to about 30 microns, greater than or equal to about 32 microns, or greater than or equal to about 35 microns. In some instances, the filtration layer may have a mean flow pore size of less than or equal to about 40 microns, less than or equal to about 38 microns, less than or equal to about 35 microns, less than or equal to about 32 microns, less than or equal to about 30 microns, less than or equal to about 28 microns, less than or equal to about 25 microns, less than or equal to about 22 microns, less than or equal to about 20 microns, less than or equal to about 18 microns, less than or equal to about 15 microns, less than or equal to about 12 microns, less than or equal to about 10 microns, or less than or equal to about 8 microns. Combinations of the above-referenced ranges are also possible (e.g., greater than or equal to about 5 microns and less than or equal to about 40 microns, greater than or equal to about 10 microns and less than or equal to about 30 microns). The mean flow pore size may be determined according to the standard ASTM F316-03.

The mean flow pore size of the fine fiber web (e.g., meltblown web) may be greater than or equal to about 5 microns, greater than or equal to about 8 microns, greater than or equal to about 10 microns, greater than or equal to about 12 microns, greater than or equal to about 15 microns, greater than or equal to about 18 microns, or greater than or equal to about 20 microns, greater than or equal to about 22 microns, greater than or equal to about 25 microns, or greater than or equal to about 28 microns. In some instances, the fine fiber web (e.g., meltblown web) may have a mean flow pore size of less than or equal to about 30 microns, less than or equal to about 28 microns, less than or equal to about 25 microns, less than or equal to about 22 microns, less than or equal to about 20 microns, less than or equal to about 18 microns, less than or equal to about 15 microns, less than or equal to about 12 microns, less than or equal to about 10 microns, less than or equal to about 8 microns, or less than or equal to about 5 microns. Combinations of the above-referenced ranges are also possible (e.g., greater than or equal to about 5 microns and less than or equal to about 30 microns, greater than or equal to about 10 microns and less than or equal to about 25 microns). The mean flow pore size may be determined according to the standard ASTM F316-03.

The mean flow pore size of one or more coarse fiber webs (e.g., meltblown fiber web) may be greater than or equal to about 10 microns, greater than or equal to about 12 microns, greater than or equal to about 15 microns, greater than or equal to about 18 microns, greater than or equal to about 20 microns, greater than or equal to about 22 microns, greater than or equal to about 25 microns, greater than or equal to about 28 microns, greater than or equal to about 30 microns, greater than or equal to about 32 microns, or greater than or equal to about 35 microns. In some instances, one or more coarse fiber webs may have a mean flow pore size of less than or equal to about 40 microns, less than or equal to about 38 microns, less than or equal to about 35 microns, less than or equal to about 32 microns, less than or equal to about 30 microns, less than or equal to about 28 microns, less than or equal to about 25 microns, less than or equal to about 22 microns, less than or equal to about 20 microns, less than or equal to about 18 microns, less than or equal to about 15 microns, or less than or equal to about 12 microns. Combinations of the above-referenced ranges are also possible (e.g., greater than or equal to about 10 microns and less than or equal to about 40 microns, greater than or equal to about 10 microns and less than or equal to about 30 microns). The mean flow pore size may be determined according to the standard ASTM F316-03.

In some embodiments, the filtration layer in a planar configuration (e.g., prior to waving) may have a relatively low initial pressure drop. For instance, in some embodiments, the initial pressure drop of the filtration later may be less than or equal to about 25 mm H₂O, less than or equal to about 22 mm H₂O, less than or equal to about 20 mm H₂O, less than or equal to about 18 mm H₂O, less than or equal to about 15 mm H₂O, less than or equal to about 12 mm H₂O, less than or equal to about 10 mm H₂O, less than or equal to about 8 mm H₂O, less than or equal to about 5 mm H₂O, less than or equal to about 2 mm H₂O, or less than or equal to about 1 mm H₂O. In some instances, the initial pressure drop may be greater than or equal to about 0.5 mm H₂O, greater than or equal to about 1 mm H₂O, greater than or equal to about 2 mm H₂O, greater than or equal to about 5 mm H₂O, greater than or equal to about 8 mm H₂O, greater than or equal to about 10 mm H₂O, greater than or equal to about 12 mm H₂O, greater than or equal to about 15 mm H₂O, greater than or equal to about 18 mm H₂O, or greater than or equal to about 20 mm H₂O, or greater than or equal to about 22 mm H₂O. It should be understood that combinations of the above-referenced ranges are possible (e.g., greater than or equal to about 0.5 mm H₂O and less than or equal to about 25 mm H₂O, greater than or equal to about 0.5 mm H₂O and less than or equal to about 20 mm H₂O, greater than or equal to about 1 mm H₂O and less than or equal to about 15 mm H₂O, greater than or equal to about 2 mm H₂O and less than or equal to about 10 mm H₂O). As used herein, “initial pressure drop” refers to the pressure drop measured before loading with any particulate matter using air free of particulate matter. Pressure drop is measured as the differential pressure across the filter media or filtration layer when exposed to a face velocity of approximately 12.7 centimeters per second. The face velocity is the velocity of air as it hits the upstream side of the filter media or filtration layer. Values of pressure drop are typically recorded as millimeters of water or Pascals. The values of initial pressure drop described herein are determined according to EN779 2012.

In some embodiments, at least a portion (e.g., substantially all, entire) of one or more fiber webs (e.g., coarse fiber web, fine fiber web) and/or one or more layers (e.g., a filtration layer, a support layer) of the filter media may be modified such that at least a portion (e.g., substantially all, entire) of a surface of the one or more fiber webs and/or one or more layers (and/or at least a portion of the surface of the fibers) is hydrophilic. In certain embodiments, one or both of the top (e.g., upstream) and the bottom (e.g., downstream) surfaces of a fiber web (e.g., coarse fiber web, fine fiber web) and/or layer (e.g., a filtration layer, a support layer) are modified. In other embodiments, the fiber web (e.g., coarse fiber web, fine fiber web) and/or layer (e.g., a filtration layer, a support layer) is modified at a depth beneath the surface, and in some cases, throughout the thickness of the fiber web and/or layer. In certain embodiments, a fiber web and/or layer is modified using chemical vapor deposition, topical application of a coating (e.g., via a spray method, a dip method, flexographic or reverse roll application), incorporation of hydrophilic melt additives, incorporation of hydrophilic fibers, or combinations thereof. Other (surface) modification techniques may also be used. For instance, the fiber web (e.g., coarse fiber web, fine fiber web) and/or layer (e.g., filtration layer, support layer) may comprise a chemical vapor deposition coating.

In some embodiments, the hydrophilic modification of a fiber web and/or layer may be conducted at any suitable time. For example, at least a surface of a fiber web (e.g., coarse fiber web, fine fiber web) and/or layer (e.g., filtration layer, support layer) may be modified to be hydrophilic after formation of fiber web and/or the layer and/or during formation of the fiber web and/or layer (e.g., during a meltblown process, an electrospinning process, etc., as described herein). In certain embodiments, at least a surface of the fiber web and/or layer may be modified to be hydrophilic during and/or after formation of the waved configuration of the fiber web and/or layer.

In some embodiments, at least one surface of the fiber web (e.g., coarse fiber web, fine fiber web) and/or layer (e.g., filtration layer, support layer) may be modified to make the surface hydrophilic or increase the hydrophilicity of the surface. For example, a hydrophilic surface having a water contact angle of about 60° may be modified to have a water contact angle of about 15°. In another example, a hydrophobic surface having a water contact angle of about 100° may be modified to have a water contact angle of less than 90° (e.g., a water contact angle of less than 60°).

As used herein, the term “hydrophilic” refers to material that has a water contact angle of less than 90 degrees. A material generally becomes more hydrophilic as the water contact angle decreases. Accordingly, a “hydrophilic surface” may refer to a surface that has a water contact angle of less than 90 degrees. In some embodiments, the surface may be modified to be hydrophilic such that the water contact angle is less than 90 degrees, less than or equal to about 80 degrees, less than or equal to about 75 degrees, less than or equal to about 70 degrees, less than or equal to about 65 degrees, less than or equal to about 60 degrees, less than or equal to about 55 degrees, less than or equal to about 50 degrees, less than or equal to about 45 degrees, less than or equal to about 40 degrees, less than or equal to about 35 degrees, less than or equal to about 30 degrees, less than or equal to about 25 degrees, less than or equal to about 20 degrees, or less than or equal to about 15 degrees. In some embodiments, the water contact angle is greater than or equal to about 0 degrees, greater than or equal to about 5 degrees, greater than or equal to about 10 degrees, greater than or equal to about 15 degrees, greater than or equal to about 20 degrees, greater than or equal to about 25 degrees, greater than or equal to about 35 degrees, greater than or equal to about 45 degrees, or greater than about 60 degrees. Combinations of the above-referenced ranges are also possible (e.g., greater than or equal to about 0 degrees and less than about 90 degrees, greater than or equal to about 0 degrees and less than about 60 degrees). In an exemplary embodiment, the contact angle of the surface (e.g., after modification) is less than or equal to 60 degrees. The water contact angle may be measured using ASTM D5946-04. The water contact angle is the angle between the surface (e.g., a surface of the filtration layer) and the tangent line drawn to the water droplet surface at the three-phase point, when a liquid drop is resting on a plane solid surface. A contact angle meter or goniometer can be used for this determination. In some embodiments, the hydrophilicity of the surface may be such that a water droplet placed on the surface completely wets the surface (e.g., the water droplets is completely absorbed into the material making the water contact angle 0).

In some embodiments, the decrease in water contact angle of at least one surface of the fiber web and/or layer upon modification as described herein is greater than or equal to about 0 degrees, greater than or equal to about 1 degree, greater than or equal to about 2 degrees, greater than or equal to about 5 degrees, greater than or equal to about 10 degrees, greater than or equal to about 15 degrees, greater than or equal to about 20 degrees, greater than or equal to about 25 degrees, greater than or equal to about 35 degrees, greater than or equal to about 45 degrees, greater than or equal to about 60 degrees, greater than or equal to about 75 degrees, greater than or equal to about 80 degrees, or greater than or equal to about 90 degrees as compared to the water contact angle of the at least one surface prior to modification. In certain embodiments, the decrease in water contact angle of at least one surface of the fiber web and/or layer upon modification is less than or equal to about 100 degrees, less than or equal to about 90 degrees, less than or equal to about 80 degrees, less than or equal to about 75 degrees, less than or equal to about 70 degrees, less than or equal to about 65 degrees, less than about 60 degrees, less than or equal to about 55 degrees, less than or equal to about 50 degrees, less than or equal to about 45 degrees, less than or equal to about 40 degrees, less than or equal to about 35 degrees, less than or equal to about 30 degrees, less than or equal to about 25 degrees, less than or equal to about 20 degrees, less than or equal to about 15 degrees, less than or equal to about 10 degrees, less than or equal to about 5 degrees, or less than or equal to about 2 degrees as compared to the water contact angle of the at least one surface prior to modification. Combinations of the above-referenced ranges are also possible (e.g., greater than or equal to 0 degrees and less than or equal to 100 degrees). Other ranges are also possible.

In some embodiments, the fiber web and/or layer may comprise fibers that may be modified such that at least a surface of the fiber web (e.g., coarse fiber web, fine fiber web) and/or layer (e.g., filtration layer, support layer) comprising said fibers is hydrophilic. In some cases, the fibers may be hydrophilic. In some embodiments, the fibers may be hydrophobic and may be modified to be hydrophilic. Non-limiting examples of fibers that may be may be modified (e.g., to enhance or impart hydrophilicity) may comprise a polymer such as polyolefins (e.g., polypropylene, polyethylene, polybutene, copolymers of olefinic monomers such as ethylene or propylene), polyesters (e.g., polybutylene terephthalate (PBT), polyethylene terephthalate (PET), CoPET, polylactic acid (PLA)), polyamides (e.g., nylons such as polyamid 6 (PA6), polyamid 11 (PA 11), aramids), polycarbonates, and combinations thereof (e.g., polylactic acid/polystyrene, PEN/PET polyester, copolyamides). In cases in which the fiber is hydrophilic (e.g., polylactic acid, PA6), the fiber may be modified to enhance the hydrophilicity of the fiber. In an exemplary embodiment, the fiber may have a water contact angle of greater than 60 degrees (e.g., greater than 60 degrees and less than 90 degrees) and is modified such that the water contact angle is less than or equal to 60 degrees (e.g., greater than or equal to 0 degrees and less than or equal to 60 degrees).

In some embodiments, a gas may be used to modify the hydrophilicity of at least one surface of the fiber web (e.g., coarse fiber web, fine fiber web) and/or layer (e.g., the filtration layer, the support layer). For example, after formation, the fiber web and/or layer may be exposed to a gaseous environment. In some such cases, the molecules in the gas may react with material (e.g., fibers, resin, additives) on the surface of the fiber web and/or layer to form functional groups, such as charged moieties, and/or to increase the oxygen content on the surface of the fiber web and/or layer. Non-limiting examples of functional groups include hydroxyl, carbonyl, ether, ketone, aldehyde, acid, amide, acetate, phosphate, sulfite, sulfate, amine, nitrile, and nitro groups. Non-limiting examples of gases that may be reacted with at least one surface of the fiber web and/or layer includes CO₂, SO₂, SO₃, NH₃, N₂H₄, N₂, O₂, H₂, He, Ar, NO, air and combinations thereof.

In certain embodiments, a coating (e.g., a polymeric coating) may be used to modify the hydrophilicity of at least a surface of the fiber web (e.g., fine fiber web, coarse fiber web) and/or layer (e.g., the filtration layer, the support layer). For example, after formation of the fiber web and/or layer, the coating may be applied to at least a surface of the fiber web and/or layer. In certain embodiments, the coating comprises an acrylate (e.g., acrylamide, (Hydroxyethyl) methacrylate), carboxylic acid (e.g., acrylic acid, citric acid), a sulfonate (e.g., 1,3-propane sultone, N-hydroxysulfosuccinimide, methyl trifluoromethanesulfonate), a polyol (e.g., glycerin, pentaerythritol, ethylene glycol, propylene glycol, sucrose), an amine (e.g., allylamine, ethyleneimine, oxazoline), a silicon-containing compound (e.g., tetraethyl orthosilicate, hexamethyldisiloxane, silane), and combinations thereof. In some embodiments, the coating may be applied independently, as a mixture of two or more coatings, or sequentially (e.g., coating a first coating with a second coating).

In some embodiments, a wetting agent (e.g., a surfactant) may be used to modify the hydrophilicity of at least one surface of the fiber web and/or layer. For example, after formation of the fiber web and/or layer, the wetting agent may be applied to at least a surface of the fiber web and/or layer. Non-limiting examples of suitable wetting agents include anionic surfactants (e.g., sodium dioctylsulfosuccinate, disodium salts of alkyl polyglucoside esters), nonionic surfactants (e.g., alkyl phenol ethoxylates, alcohol ethoxylates, polyglycerol esters, polyglucosides), cationic surfactants (e.g., quaternary ammonium compounds of the general formula R₁R₂R₃R₄N⁺X⁻ wherein each of R₁, R₂, R₃, and R₄ represent the same or different alkyl groups and X⁻ is a halide such as a chloride ion), amphoteric surfactants (e.g., surfactants comprising cationic and anionic groups such as N-alkyl betaines), and combinations thereof.

In some embodiments, the fiber web and/or layer may be dipped in a material (e.g., a coating, a surfactant). In certain embodiments, the material may be sprayed on the fiber web and/or layer. The weight percent of the material (e.g., coating, surfactant, functional group) used to modify at least one surface of the fiber web (e.g., fine fiber web, coarse fiber web) and/or layer (e.g., the filtration layer, the support layer) may be greater than or equal to about 0.0001 wt %, greater than or equal to about 0.0005 wt %, greater than or equal to about 0.001 wt %, greater than or equal to about 0.005 wt %, greater than or equal to about 0.01 wt %, greater than or equal to about 0.05 wt %, greater than or equal to about 0.1 wt %, greater than or equal to about 0.5 wt %, greater than or equal to about 1 wt %, greater than or equal to about 2 wt %, or greater than or equal to about 4 wt % versus the total weight of the fiber web and/or layer. In some cases, the weight percentage of the material used to modify at least one surface of the fiber web and/or layer may be less than or equal to about 5 wt %, less than or equal to about 3 wt %, less than or equal to about 1 wt %, less than or equal to about 0.5 wt %, less than or equal to about 0.1 wt %, less than or equal to about 0.05 wt %, less than or equal to about 0.01 wt %, or less than or equal to about 0.005 wt % versus the total weight of the fiber web and/or layer. Combinations of the above-referenced ranges are also possible (e.g., a weight percentage of material of greater than or equal to about 0.0001 wt % and less than about 5 wt %). Other ranges are also possible. The weight percentage of material in the fiber web and/or layer is based on the dry solids of the fiber web and/or layer and can be determined by weighing the fiber web and/or layer before and after the modification of the surface as described herein.

In some cases, a melt additive may be incorporated into a fiber, a fiber web, and/or a layer to enhance the hydrophilicity of the fiber web and/or layer. For example, in certain embodiments, a melt additive may be used to modify the hydrophilicity of at least a surface of the fiber web (e.g., coarse fiber web, fine fiber web) and/or layer (e.g., the filtration layer, the support layer). In some cases, the melt additive (e.g., a hydrophilic melt additive) may be blended with one or more fibers of the fiber web and/or layer (e.g., during formation of the fibers, during formation of the fiber web, and/or during formation of the layer). Non-limiting examples of suitable (hydrophilic) melt additives include monoglycerides, mixed glycerides, di-fatty acid esters of polyethylene oxide, ethoxylated castor oil, blends of glycerol oleate esters and alkyl phenol ethoxylates, and polyethylene glycol esters of fatty acids. Other hydrophilic melt additives are also possible.

In some cases, the melt additive may comprise a preblended masterbatch melt additive. Preblended masterbatch melt additives are known in the art and one of ordinary skill would be capable of incorporating preblended masterbatch melt additives into a fiber web and/or layer (e.g., filtration layer) such that at least a surface of the fiber web and/or layer (e.g., filtration layer) is hydrophilic, based upon the teachings of this specification.

The weight percent of the melt additive (or preblended masterbatch melt additive) used to modify at least one surface of the fiber web and/or layer may be greater than or equal to about 0.0001 wt %, greater than or equal to about 0.0005 wt %, greater than or equal to about 0.001 wt %, greater than or equal to about 0.005 wt %, greater than or equal to about 0.01 wt %, greater than or equal to about 0.05 wt %, greater than or equal to about 0.1 wt %, greater than or equal to about 0.5 wt %, greater than or equal to about 1 wt %, greater than or equal to about 2 wt %, greater than or equal to about 4 wt %, greater than or equal to about 6 wt %, or greater than or equal to about 8 wt % versus the total weight of the fiber web and/or layer. In some cases, the weight percentage of the melt additive used to modify at least one surface of the fiber web and/or layer may be less than or equal to about 10 wt %, less than or equal to about 8 wt %, less than or equal to about 5 wt %, less than or equal to about 3 wt %, less than or equal to about 1 wt %, less than or equal to about 0.5 wt %, less than or equal to about 0.1 wt %, less than or equal to about 0.05 wt %, less than or equal to about 0.01 wt %, or less than or equal to about 0.005 wt % versus the total weight of the fiber web and/or layer. Combinations of the above-referenced ranges are also possible (e.g., a weight percentage of material of greater than or equal to about 0.0001 wt % and less than about 10 wt %, or greater than or equal to about 0.0001 wt % and less than about 5 wt %). Other ranges are also possible. The weight percentage of material in the fiber web and/or layer is based on the dry solids of the fiber web and/or layer and can be determined by thermogravimetric analysis.

As described herein, a filter media can include at least one support layer. In some embodiments, the support layer may comprise fibers. In some such embodiments, the average diameter of the fibers in the support layer may be relatively large. For instance, in some embodiments, the support layer may have an average fiber diameter of greater than or equal to about 5 microns, greater than or equal to about 8 microns, greater than or equal to about 9 microns, greater than or equal to about 15 microns, greater than or equal to about 20 microns, greater than or equal to about 25 microns, greater than or equal to about 30 microns, greater than or equal to about 35 microns, greater than or equal to about 40 microns, or greater than or equal to about 45 microns. In some instances, the average fiber diameter may be less than or equal to about 50 microns, less than or equal to about 45 microns, less than or equal to about 40 microns, less than or equal to about 35 microns, less than or equal to about 30 microns, less than or equal to about 25 microns, less than or equal to about 20 microns, less than or equal to about 15 microns, or less than or equal to about 10 microns. Combinations of the above-referenced ranges are also possible (e.g., greater than or equal to about 5 microns and less than or equal to about 50 microns, greater than or equal to about 9 microns and less than or equal to about 25 microns).

In some embodiments, the fibers in one or more support layers in the filter media may have an average length of greater than or equal to about 12.0 mm, greater than or equal to about 15 mm, greater than or equal to about 20 mm, greater than or equal to about 30 mm, greater than or equal to about 40 mm, greater than or equal to about 50 mm, greater than or equal to about 60 mm, greater than or equal to about 70 mm, greater than or equal to about 80 mm, greater than or equal to about 90 mm, or greater than or equal to about 100 mm. In some instances, the average fiber length is less than or equal to about 100 mm, less than or equal to about 90 mm, less than or equal to about 80 mm, less than or equal to about 70 mm, less than or equal to about 60 mm, less than or equal to about 50 mm, less than or equal to about 40 mm, less than or equal to about 30 mm, or less than or equal to about 20 mm. Combinations of the above-referenced ranges are also possible (e.g., greater than or equal to about 12 mm and less than or equal to about 100 mm, greater than or equal to about 40 mm and less than or equal to about 80 mm).

In some embodiments, one or more support layer may have a basis weight (e.g., in the waved configuration) of greater than or equal to about 35 g/m², greater than or equal to about 40 g/m², greater than or equal to about 50 g/m², greater than or equal to about 60 g/m², greater than or equal to about 70 g/m², greater than or equal to about 80 g/m², greater than or equal to about 90 g/m², greater than or equal to about 100 g/m², greater than or equal to about 110 g/m², greater than or equal to about 120 g/m², greater than or equal to about 130 g/m², greater than or equal to about 140 g/m², greater than or equal to about 150 g/m², greater than or equal to about 160 g/m², greater than or equal to about 170 g/m², greater than or equal to about 180 g/m², or greater than or equal to about 190 g/m². In some instances, one or more support layers may have a basis weight of less than or equal to about 300 g/m², less than or equal to about 200 g/m², less than or equal to about 190 g/m², less than or equal to about 180 g/m², less than or equal to about 170 g/m², less than or equal to about 160 g/m², less than or equal to about 150/m², less than or equal to about 140 g/m², less than or equal to about 130 g/m², less than or equal to about 120 g/m², less than or equal to about 110 g/m², less than or equal to about 100/m², less than or equal to about 90 g/m², less than or equal to about 80 g/m², less than or equal to about 70 g/m², less than or equal to about 60 g/m², or less than or equal to about 50 g/m². Combinations of the above-referenced ranges are also possible (e.g., greater than or equal to about 35 g/m² and less than or equal to about 200 g/m², greater than or equal to about 70 g/m² and less than or equal to about 150 g/m²).

In general, the one or more support layers can be formed from a variety of fibers types. In some embodiments, the support layer may comprise synthetic fibers as described above with respect to the filtration layer. Synthetic fibers may also include multi-component fibers (i.e., fibers having multiple compositions such as bicomponent fibers). In some embodiments, one or more support layers may include bicomponent fibers. The bicomponent fibers may comprise a thermoplastic polymer. Each component of the bicomponent fiber can have a different melting temperature. For example, the fibers can include a core and a sheath where the activation temperature of the sheath is lower than the melting temperature of the core. This allows the sheath to melt prior to the core, such that the sheath binds to other fibers in the fiber web and/or layer, while the core maintains its structural integrity. The core/sheath binder fibers can be concentric or non-concentric. Other exemplary bicomponent fibers can include split fiber fibers, side-by-side fibers, and/or “island in the sea” fibers. In some embodiments, one or more support layers may be a carded fiber web.

As previously indicated, the filter media can also optionally include one or more cover layers. Referring to FIG. 8A, cover layer 18 may function as a dust loading layer and/or it can function as an aesthetic layer. In an exemplary embodiment, the cover layer 18 is a planar layer that is mated to the filter media 10 after the filtration layer 12 and the support layers 14, 16 are waved. The cover layer 18 may provide a top surface that is aesthetically pleasing. Referring to FIG. 8B, a filter media can alternatively or in addition include a bottom layer 18B disposed on the air outflow side O of the filter media. The bottom cover layer 18B can function as strengthening component that provides structural integrity to the filter media 10B to help maintain the waved configuration. The bottom cover layer 18B can also function to offer abrasion resistance. This may be particularly desirable in ASHRAE bag applications where the outermost layer is subject to abrasion during use. The cover layer(s) can also be formed using various techniques known in the art, including meltblowing, wet laid techniques, air laid techniques, carding, electrospinning, and spunbonding. In some embodiments, the cover layer can be an extruded mesh and/or laid scrim. In an exemplary embodiment, however, the cover layer 18 is an airlaid layer and the cover layer 18B is a spunbond layer.

Filter media comprising a waved filtration layer, as described herein, may have beneficial filtration properties, including low pressure drop, high efficiency, and/or long service life, amongst other beneficial properties.

In some embodiments, the thickness of the filter media may be greater than or equal to 50 mil, greater than or equal to about 75 mil, greater than or equal to about 100 mil, greater than or equal to about 200 mil, greater than or equal to about 300 mil, greater than or equal to about 400 mil, greater than or equal to about 500 mil, greater than or equal to about 600 mil, greater than or equal to about 700 mil, greater than equal to 800 mil, greater than or equal to about 900 mil, greater than or equal to about 1,000 mil, greater than or equal to about 1,100 mil, greater than or equal to about 1,200 mil, greater than or equal to about 1,300 mil, greater than or equal to about 1,400 mil, greater than or equal to about 1,500 mil, greater than or equal to about 1,600 mil, greater than or equal to about 1,700 mil, greater than equal to 1,800 mil, greater than equal to 1,900 mil, or greater than or equal to about 2,000 mil. In some instances, the thickness may be less than or equal to about 2,000 mil, less than or equal to about 1,900 mil, less than or equal to about 1,800 mil, less than or equal to about 1,700 mil, less than or equal to about 1,600 mil, less than about 1,500 mil, less than or equal to about 1,400 mil, less than or equal to about 1,300 mil, less than or equal to about 1,200 mil, less than or equal to about 1,100 mil, less than or equal to about 1,000 mil, less than or equal to about 900 mil, less than or equal to about 800 mil, less than or equal to about 700 mil, less than or equal to about 600 mil, less than or equal to about 500 mil, less than about 400 mil, less than or equal to about 300 mil, less than or equal to about 200 mil, or less than or equal to about 100 mil. Combinations of the above-referenced ranges are possible (e.g., greater than or equal to about 50 mil and less than or equal to about 1,000 mil, greater than or equal to about 100 mil and less than or equal to about 400 mil).

In some embodiments, the filter media may have a basis weight of greater than or equal to about 30 g/m², greater than or equal to about 50 g/m², greater than or equal to about 70 g/m², greater than or equal to about 90 g/m², greater than or equal to about 100 g/m², greater than or equal to about 125 g/m², greater than or equal to about 150 g/m², greater than or equal to about 175 g/m², greater than or equal to about 200 g/m², greater than or equal to about 225 g/m², greater than or equal to about 250 g/m², greater than or equal to about 275 g/m², greater than or equal to about 300 g/m², greater than or equal to about 325 g/m², greater than or equal to about 350 g/m², or greater than or equal to about 375 g/m². In some instances, the filter media may have a basis weight of less than or equal to about 400 g/m², less than or equal to about 375 g/m², less than or equal to about 350 g/m², less than or equal to about 325 g/m², less than or equal to about 300 g/m², less than or equal to about 275 g/m², less than or equal to about 250 g/m², less than or equal to about 225 g/m², less than or equal to about 200 g/m², less than or equal to about 175 g/m², less than or equal to about 150 g/m², less than or equal to about 125 g/m², less than or equal to about 100 g/m², less than or equal to about 75 g/m², or less than or equal to about 50 g/m². Combinations of the above-referenced ranges are possible (e.g., greater than or equal to about 30 g/m² and less than or equal to about 400 g/m², greater than or equal to about 90 g/m² and less than or equal to about 250 g/m²).

In some embodiments, the filter media may have an air permeability of greater than or equal to about 20 CFM, greater than or equal to about 30 CFM, greater than or equal to about 50 CFM, greater than or equal to about 100 CFM, greater than or equal to about 200 CFM, greater than or equal to about 300 CFM, greater than or equal to about 400 CFM, greater than or equal to about 500 CFM, greater than or equal to about 600 CFM, greater than or equal to about 700 CFM, greater than or equal to about 800 CFM, or greater than or equal to about 900 CFM. In some instances, the filter media may have an air permeability of less than or equal to about 1,000 CFM, less than or equal to about 900 CFM, less than or equal to about 800 CFM, less than or equal to about 700 CFM, less than or equal to about 600 CFM, less than or equal to about 500 CFM, less than or equal to about 400 CFM, less than or equal to about 300 CFM, less than or equal to about 200 CFM, less than or equal to about 100 CFM, or less than or equal to about 50 CFM. Combinations of the above-referenced ranges are possible (e.g., greater than or equal to about 20 CFM and less than or equal to about 1,000 CFM, greater than or equal to about 30 CFM and less than or equal to about 400 CFM). The air permeability may be determined according to the standard TAPPI T-215 using a test area of 38 cm² and a pressure drop of 0.5 inches.

The filtration layer may impart advantageous performance properties to the filter media, including high efficiency and relatively low pressure drop. In some embodiments, the filter media may have a relatively high efficiency. For instance, in some embodiments, the initial efficiency of the filter media may be greater than or equal to about 15%, greater than or equal to about 20%, greater than or equal to about 30%, greater than or equal to about 40%, greater than or equal to about 50%, greater than or equal to about 60%, greater than or equal to about 70%, greater than or equal to about 80%, greater than or equal to about 95%, greater than or equal to about 96%, greater than or equal to about 97%, greater than or equal to about 98%, greater than or equal to about 99%, or greater than or equal to about 99.9%. In some instances, the initial efficiency of the filter media may be less than or equal to about 99.9%, less than or equal to about 98%, less than or equal to about 97%, less than or equal to about 96%, less than or equal to about 95%, less than or equal to about 90%, less than or equal to about 80%, less than or equal to about 70%, less than or equal to about 60%, less than or equal to about 50%, less than or equal to about 40%, or less than or equal to about 30%. Combinations of the above-referenced ranges are also possible (e.g., greater than or equal to about 15% and less than or equal to about 99.9%, greater than or equal to about 20% and less than or equal to about 95%). The initial efficiency may be determined according to standard EN 779 2012. The initial efficiency is the first efficiency measurement taken at the beginning of the test according to EN 779:2012. The initial efficiency is taken on a sample that has not been loaded with any particulate matter prior to testing.

Because it may be desirable to rate filter media based on the relationship between efficiency and pressure drop across the media, or particulate efficiency as a function of pressure drop across the media or web, filters may be rated according to a value termed gamma value. Generally, higher gamma values are indicative of better filter performance, i.e., a high particulate efficiency as a function of pressure drop. Gamma value is expressed according to the following formula:

gamma=(−log(initial penetration %/100)/initial pressure drop, Pa)×100×9.8, which is equivalent to:

gamma=(−log(initial penetration %/100)/initial pressure drop, mm H₂O)×100, wherein initial penetration %=100−initial efficiency

With decreased initial penetration percentage (i.e., increased particulate efficiency) where particles are less able to penetrate through the filter media, gamma increases. With decreased initial pressure drop (i.e., low resistance to fluid flow across the filter), gamma increases. These generalized relationships between initial penetration, initial pressure drop, and/or gamma assume that the other properties remain constant.

In general, the filter media may have a relatively high gamma. In some instances, the filter media may have a gamma of greater than or equal to about 2, greater than or equal to about 5, greater than or equal to about 8, greater than or equal to about 10, greater than or equal to about 15, greater than or equal to about 20, greater than or equal to about 30, greater than or equal to about 40, greater than or equal to about 50, greater than or equal to about 60, greater than or equal to about 70, greater than or equal to about 80, or greater than or equal to about 90. In some instances, the filter media may have a gamma of less than or equal to about 100, less than or equal to about 90, less than or equal to about 80, less than or equal to about 70, less than or equal to about 60, less than or equal to about 50, less than or equal to about 40, less than or equal to about 30, less than or equal to about 25, less than or equal to about 20, less than or equal to about 15, or less than or equal to about 10. It should be understood that combinations of the above-referenced ranges are possible (e.g., greater than or equal to about 2 and less than or equal to about 100, greater than or equal to about 8 and less than or equal to about 40).

It should be understood that the gamma and initial efficiency values, described herein, may be obtained using an uncharged layer, such that particle separation is substantially or solely mechanical. For example, the filter media may be discharged or otherwise treated, such that only mechanical particle separation occurs. In other embodiments, the fiber web, layer, and/or filter media may be charged and particle separation may not be substantially or solely due mechanical particle separation.

In some embodiments, the initial pressure drop of the filter media may be relatively low. For instance, in some embodiments, the filter media may have an initial pressure drop of less than or equal to about 30 mm H₂O, less than or equal to about 28 mm H₂O, less than or equal to about 25 mm H₂O, less than or equal to about 22 mm H₂O, less than or equal to about 20 mm H₂O, less than or equal to about 18 mm H₂O, less than or equal to about 15 mm H₂O, less than or equal to about 12 mm H₂O, less than or equal to about 10 mm H₂O, less than or equal to about 8 mm H₂O, less than or equal to about 5 mm H₂O, or less than or equal to about 1 mm H₂O. In some instances, the filter media may have an initial pressure drop of greater than or equal to about 0.5 mm H₂O, greater than or equal to about 1 mm H₂O, greater than or equal to about 2 mm H₂O, greater than or equal to about 5 mm H₂O, greater than or equal to about 8 mm H₂O, greater than or equal to about 10 mm H₂O, greater than or equal to about 12 mm H₂O, greater than or equal to about 15 mm H₂O, greater than or equal to about 18 mm H₂O, greater than or equal to about 20 mm H₂O, greater than or equal to about 22 mm H₂O, or greater than or equal to about 25 mm H₂O. Combinations of the above-referenced ranges are also possible (e.g., greater than or equal to about 0.5 mm H₂O and less than or equal to about 30 mm H₂O, greater than or equal to about 1 mm H₂O and less than or equal to about 15 mm H₂O). The pressure drop, as described herein, can be determined EN 779 2012.

In some embodiments, the change in pressure drop of the filter media over time may be relatively low. For instance, in some embodiments, the change in pressure drop of the filter media after 25 minutes of NaCl loading as determined by the EN 779 2012 standard, except 0.3 micron NaCl particles are used instead of ASHRAE dust, may be less than or equal to about 12 mm H₂O, less than or equal to about 11 mm H₂O, less than or equal to about 10 mm H₂O, less than or equal to about 9 mm H₂O, less than or equal to about 8 mm H₂O, less than or equal to about 7 mm H₂O, less than or equal to about 6 mm H₂O, less than or equal to about 5 mm H₂O, or less than or equal to about 4 mm H₂O. In some instances, the change in pressure drop may be greater than or equal to about 3 mm H₂O, greater than or equal to about 4 mm H₂O, greater than or equal to about 5 mm H₂O, greater than or equal to about 6 mm H₂O, greater than or equal to about 7 mm H₂O, greater than or equal to about 8 mm H₂O, greater than or equal to about 9 mm H₂O, greater than or equal to about 10 mm H₂O, or greater than or equal to about 11 mm H₂O. It should be understood that combinations of the above-referenced ranges are possible (e.g., greater than or equal to about 3 mm H₂O and less than or equal to about 12 mm H₂O, greater than or equal to about 5 mm H₂O and less than or equal to about 8 mm H₂O). The change in pressure drop may be determined by subtracting the initial pressure drop from the pressure drop after 25 minutes of NaCl loading.

In some embodiments, the change in pressure drop of the filter media, as determined after 25 minutes of ASHRAE dust loading according to EN 779 2012, may be greater than or equal to about 3 mm H₂O, greater than or equal to about 7 mm H₂O, greater than or equal to about 10 mm H₂O, greater than or equal to about 15 mm H₂O, greater than or equal to about 20 mm H₂O, greater than or equal to about 25 mm H₂O, greater than or equal to about 40 mm H₂O, greater than or equal to about 50 mm H₂O, greater than or equal to about 60 mm H₂O, greater than or equal to about 70 mm H₂O, greater than or equal to about 80 mm H₂O, or greater than or equal to about 90 mm H₂O. In some instances, the change in pressure drop may be less than or equal to about 100 mm H₂O, less than or equal to about 90 mm H₂O, less than or equal to about 75 mm H₂O, less than or equal to about 60 mm H₂O, less than or equal to about 50 mm H₂O, less than or equal to about 40 mm H₂O, less than or equal to about 30 mm H₂O, less than or equal to about 20 mm H₂O, or less than or equal to about 10 mm H₂O. It should be understood that combinations of the above-referenced ranges are possible (e.g., greater than or equal to about 3 mm H₂O and less than or equal to about 100 mm H₂O, greater than or equal to about 7 mm H₂O and less than or equal to about 75 mm H₂O). The change in pressure drop may be determined by subtracting the initial pressure drop from the pressure drop after 25 minutes of ASHRAE dust loading.

In some embodiments, the weight percentage of the filtration layer in the filter media may be greater than or equal to about 5%, greater than or equal to about 10%, greater than or equal to about 20%, greater than or equal to about 30%, greater than or equal to about 40%, greater than or equal to about 50%, greater than or equal to about 60%, greater than or equal to about 70%, or greater than or equal to about 80%. In some instances, the weight percentage of the filtration layer in the filter media may be less than or equal to about 90%, less than or equal to about 80%, less than or equal to about 70%, less than or equal to about 60%, less than or equal to about 50%, less than or equal to about 40%, less than or equal to about 30%, less than or equal to about 20%, or less than or equal to about 10%. Combinations of the above-referenced ranges are also possible (e.g., greater than or equal to about 5% and less than or equal to about 90%, greater than or equal to about 10% and less than or equal to about 50%).

In some embodiments, the weight percentage of one or more support layers in the filter media may be greater than or equal to about 20%, greater than or equal to about 30%, greater than or equal to about 40%, greater than or equal to about 50%, greater than or equal to about 60%, greater than or equal to about 70%, or greater than or equal to about 80%. In some instances, the weight percentage of one or more support layers in the filter media may be less than or equal to about 90%, less than or equal to about 80%, less than or equal to about 70%, less than or equal to about 60%, less than or equal to about 50%, less than or equal to about 40%, or less than or equal to about 30%. Combinations of the above-referenced ranges are also possible (e.g., greater than or equal to about 20% and less than or equal to about 90%, greater than or equal to about 40% and less than or equal to about 80%).

Filter media described herein may be produced using suitable processes, such as using a non-wet laid or a wet laid process. In some embodiments, a fiber web and/or the filter media described herein may be produced using a non-wet laid process, such as blowing or spinning process. In some embodiments, a fiber web (e.g., fine fiber web) and/or layer may be formed by an electrospinning process. In some embodiments, electrospinning utilizes a high voltage differential to generate a fine jet of polymer solution from bulk polymer solution. The jet forms as the polymer is charged by the potential and electrostatic repulsion forces overcome the surface tension of the solution. The jet gets drawn into a fine fiber under the effect of repulsive electrical forces applied to the solution. The jet dries in flight and is collected on a grounded collector. The rapid solvent evaporation during this process leads to the formation of polymeric nanofiber which are randomly arranged into a web. In some embodiments, electrospun fibers are made using non-melt fiberization processes. Electrospun fibers can be made with any suitable polymers including but not limiting to, organic polymers, inorganic material (e.g., silica), hybrid polymers, and any combination thereof. In some embodiments, the synthetic fibers, described herein, may be formed from an electrospinning process.

In certain embodiments, a fiber web (e.g., first coarse fiber web, second coarse fiber web, fine fiber web, coarse fiber web), the filtration layer, the coarse fiber layer, and/or the entire filter media may be formed by a meltblowing system, such as the meltblown system described in U.S. Publication No. 2009/0120048, filed Nov. 7, 2008, and entitled “Meltblown Filter Medium”, and U.S. Publication No. 2012-0152824, filed Dec. 17, 2010, and entitled, “Fine Fiber Filter Media and Processes”, each of which is incorporated herein by reference in its entirety for all purposes. In certain embodiments, a fiber web (e.g., first fiber web, second fiber web) and/or the entire filter media may be formed by a meltspinning or a centrifugal spinning process.

In some embodiments, a non-wet laid process, such as an air laid or carding process, may be used to form one or more fiber webs or layers (e.g., support layer). For example, in an air laid process, synthetic fibers may be mixed, while air is blown onto a conveyor. In a carding process, in some embodiments, the fibers are manipulated by rollers and extensions (e.g., hooks, needles) associated with the rollers. In some cases, forming the fiber webs through a non-wet laid process may be more suitable for the production of a highly porous media. In some embodiments, a non-wet laid process (e.g., electrospun, meltblown) may be used to form the first fiber web and a wet laid process may be used to from the second fiber web. The first fiber web and the second fiber web may be combined using any suitable process (e.g., lamination, calendering).

In some embodiments, a fiber web, a layer, and/or the filter media described herein may be produced using a wet laid process. In general, a wet laid process involves mixing together of fibers of one or more type; for example, polymeric staple fibers of one type may be mixed together with polymeric staple fibers of another type, and/or with fibers of a different type (e.g., synthetic fibers and/or glass fibers), to provide a fiber slurry. The slurry may be, for example, aqueous-based slurry. In certain embodiments, fibers, are optionally stored separately, or in combination, in various holding tanks prior to being mixed together (e.g., to achieve a greater degree of uniformity in the mixture).

During or after formation of a filter media, the filter media may be further processed according to a variety of known techniques. For instance, a coating method may be used to include a resin in the filter media. Optionally, additional fiber webs can be formed and/or added to a filter media using processes such as lamination, co-pleating, or collation. As described herein, in some embodiments two or more fiber webs of the filter media (e.g., fine fiber web and coarse fiber web) may be formed separately and combined by any suitable method such as lamination, calendering, collation, or by use of adhesives. The two or more fiber webs may be formed using different processes (e.g., electrospinning, meltblowing), or the same process (e.g., meltbowing). For example, each of the fiber webs may be independently formed by a non-wet laid process (e.g., meltblowing process, melt spinning process, centrifugal spinning process, electrospinning process, dry laid process, air laid process), a wet laid process, or any other suitable process.

Different fiber webs may be adhered together by any suitable method. For instance, fiber webs may be adhered using compressive techniques (e.g., lamination). Fiber webs may also be adhered by chemical bonding, adhesive and/or melt-bonded to one another on either side.

Lamination may involve, for example, compressing two or more fiber webs (e.g., first and second fiber webs) together using a flatbed laminator or any other suitable device at a particular pressure and temperature for a certain residence time (i.e., the amount of time spent under pressure and heat). For instance, the pressure may be between about 5 psi to about 150 psi (e.g., between about 30 psi to about 90 psi, between about 60 psi to about 120 psi, between about 30 and 60 psi, or between about 90 psi and about 120 psi); the temperature may be between about 75° F. and about 400° F. (e.g., between about 75° F. and about 300° F., between about 200° F. and about 350° F., or between about 275° F. and about 390° F.); and the residence time between about 1 second to about 60 seconds (e.g., between about 1 second to about 30 seconds, between about 10 second to about 25 seconds, or between about 20 seconds and about 40 seconds). Other ranges for pressure, temperature, and residence time are also possible.

Calendering may involve, for example, compressing two or more fiber webs (e.g., first and second fiber webs) together using calender rolls under a particular pressure, temperature, and line speed. For instance, the pressure may be between about 5 psi to about 150 psi (e.g., between about 30 psi to about 90 psi, between about 60 psi to about 120 psi, between about 30 and 60 psi, or between about 90 psi and about 120 psi); the temperature may be between about 75° F. and about 400° F. (e.g., between about 75° F. and about 300° F., between about 200° F. and about 350° F., or between about 275° F. and about 390° F.); and the line speed may be between about 5 ft/min to about 100 ft/min (e.g., between about 5 ft/min to about 80 ft/min, between about 10 ft/min to about 50 ft/min, between about 15 ft/min to about 100 ft/min, or between about 20 ft/min to about 90 ft/min). Other ranges for pressure, temperature, and line speed are also possible.

In some embodiments, further processing may involve pleating the filter media. In some cases, the filter media, or various fiber webs thereof, may be suitably pleated by forming score lines at appropriately spaced distances apart from one another, allowing the filter media to be folded. It should be appreciated that any suitable pleating technique may be used.

The filter media may include any suitable number of fiber webs, e.g., at least 2, at least 3, at least 4, at least 5, at least 6, at least 7, at least 8, at least 10, at least 12, or at least 15 fiber webs. In some embodiments, the filter media may include up to 20 fiber webs.

In one set of embodiments, the filter media may include a fine fiber web formed via an electrospinning process adhered (e.g., adhesively) to a coarse fiber web and/or coarse fiber layer formed via another process (e.g., meltblowing process). In another embodiment, the filter media may include a fine fiber web formed via a meltblowing process adhered (e.g., adhesively) to a coarse fiber web and/or coarse fiber layer formed via a meltblowing process. For instance, the fine fiber web (e.g., electrospun fiber web) may be adhesively bound to a coarse fiber web and/or coarse fiber layer (e.g., meltblown fiber web). Non-limiting example of suitable adhesive include acrylic copolymers, ethyl vinyl acetate (EVA), copolyesters, polyolefins, polyamides, polyurethanes, styrene block copolymers, thermoplastic elastomers, polycarbonates, silicones, and combinations thereof. Adhesives can be applied using different methods, such as spray coating (e.g., solution spraying if solvent or water based adhesives are used or melt spraying if hot melt adhesive is used), dip coating, kiss roll, knife coating, and gravure coating. In some embodiments, a fine fiber web (e.g., electrospun fiber web) and a coarse fiber web (e.g., meltblown fiber web) may be adhesively bound using a polymeric adhesive (e.g., acrylic copolymer) applied via spray coating. For example, an electrospun fiber web (e.g., comprising nylon fibers) and a meltblown fiber web (e.g., comprising polypropylene fibers) may be adhesively bound using a polymeric adhesive (e.g., acrylic copolymer) applied via spray coating.

Some or all of the layers can be formed into a waved configuration using various manufacturing techniques, but in an exemplary embodiment the filtration layer, at least one of the support layers, and any additional fiber webs or layers are positioned adjacent to one another in a desired arrangement from air entering side to air outflow side, and the combined layers are conveyed between first and second moving surfaces that are traveling at different speeds, such as with the second surface traveling at a speed that is slower than the speed of the first surface. A suction force, such as a vacuum force, can be used to pull the layers toward the first moving surface, and then toward the second moving surface as the layers travel from the first to the second moving surfaces. The speed difference causes the layers to form z-direction waves as they pass onto the second moving surface, thus forming peaks and troughs in the layers. The speed of each surface can be altered to obtain the desired number of waves per inch. The distance between the surfaces can also be altered to determine the amplitude of the peaks and troughs, and in an exemplary embodiment the distance is adjusted between 0.025″ to 4″. For example, the amplitude of the peaks and waves may be between about 0.1″ to 2.0″, e.g., between about 0.1″ to 1.0″ or between about 0.1″ to 2.0. For certain applications, the amplitude of the peaks and waves may be between about 0.1″ and 1.0″, between about 0.1″ and 0.5″, or between about 0.1″ and 0.3″. The properties of the different layers can also be altered to obtain a desired filter media configuration. In an exemplary embodiment the filter media has about 2 to 6 waves per inch, with a height (overall thickness) in the range of about 0.025″ to 2″, however this can vary significantly depending on the intended application. For instance, in other embodiments, the filter media may have about 2 to 4 waves per inch, e.g., about 3 waves per inch. As shown in FIG. 8A, a single wave W extends from the middle of one peak to the middle of an adjacent peak.

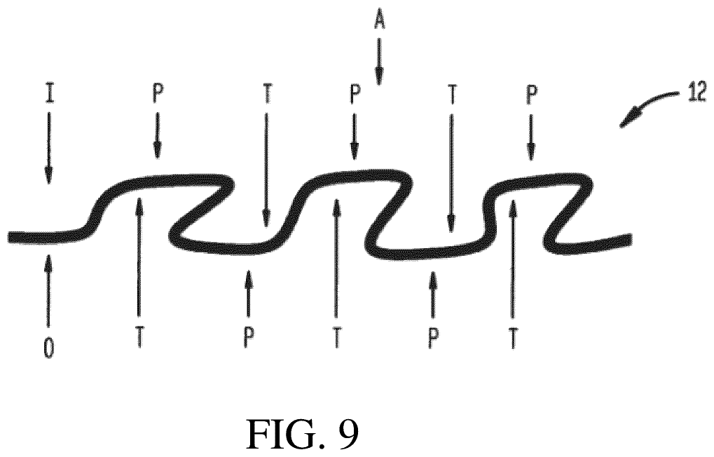

In the embodiment shown in FIG. 8A, when the filtration layer 12 and the support layer are waved, the resulting filtration layer 12 will have a plurality of peaks P and troughs T on each surface (i.e., air entering side I and air outflow side O) thereof, as shown in FIG. 9. The support layer will extend across the peaks P and into the troughs T so that the support layer also have waved configurations. A person skilled in the art will appreciate that a peak P on the air entering side I of the filtration layer will have a corresponding trough T on the air outflow side O. Thus, a downstream support layer will extend into a trough T, and exactly opposite that same trough T is a peak P, across which an upstream support layer will extend. Since the downstream support layer extends into the troughs T on the air outflow side O of the filtration layer, the downstream support layer, if provided, will maintain adjacent peaks P on the air outflow side O at a distance apart from one another and will maintain adjacent troughs T on the air outflow side O at a distance apart from one another. The upstream support layer, if provided, can likewise maintain adjacent peaks P on the air entering side I of the filtration layer at a distance apart from one another and can maintain adjacent troughs T on the air entry side I of the filtration layer at a distance apart from one another. As a result, the filtration layer has a surface area that is significantly increased, as compared to a surface area of the filtration layer in the planar configuration. In certain exemplary embodiments, the surface area in the waved configuration is increased by at least about 50%, and in some instances as much as 120%, as compared to the surface area of the same layer in a planar configuration.

In embodiments in which the one or more support layers hold the filtration layer in a waved configuration, it may be desirable to reduce the amount of free volume (e.g., volume that is unoccupied by any fibers) in the troughs. That is, a relatively high percentage of the volume in the troughs may be occupied by the support layer(s) to give the fiber layer structural support. For example, at least 95% or substantially all of the available volume in the troughs may be filled with the support layer and the support layer may have a solidity ranging between about 1% to 90%, between about 1% to 50%, between about 10% to 50%, or between about 20% to 50%. Additionally, as shown in the exemplary embodiments of FIG. 8A, the extension of the support layer(s) across the peaks and into the troughs may be such that the surface area of the support layer in contact with a cover layer 18 is similar across the peaks as it is across the troughs. Similarly, the surface area of the support layer in contact with cover layer 18B shown in FIG. 8B may be similar across the peaks as it is across the troughs. For example, the surface area of the support layer in contact with a top or bottom layer across a peak may differ from the surface area of the support layer in contact with the cover layer(s) across a trough by less than about 70%, less than about 50%, less than about 30%, less than about 20%, less than about 10%, or less than about 5%.

In certain exemplary embodiments, the one or more support layers can have a fiber density that is greater at the peaks than it is in the troughs; and, in some embodiments, a fiber mass that is less at the peaks than it is in the troughs. In some embodiments, this can result from the coarseness of the support layer relative to the filtration layer. In particular, as the layers are passed from the first moving surface to the second moving surface, the relatively fine nature of the filtration layer may allow the support layer to conform around the waves formed in the filtration layer. As the support layer extends across a peak P, the distance traveled will be less than the distance that each support layer travels to fill a trough. As a result, the support layer may compact at the peaks, thus having an increased fiber density at the peaks as compared to the troughs, through which the layers will travel to form a loop-shaped configuration.

Once the layers are formed into a waved configuration, the waved shape can be maintained by activating the binder fibers to effect bonding of the fibers. A variety of techniques can be used to activate the binder fibers. For example, if bicomponent binder fibers having a core and sheath are used, the binder fibers can be activated upon the application of heat. If monocomponent binder fibers are used, the binder fibers can be activated upon the application of heat, steam and/or some other form of warm moisture. A person skilled in the art will also appreciate that the layers can optionally be mated to one another using various techniques other than using binder fibers. The layers can also be individually bonded layers, and/or they can be mated, including bonded, to one another prior to being waved.

In some embodiments, the filter media including the gradient portion may be formed by adhering (e.g., laminating) multiple (e.g., four, five, six, seven, eight, etc.) separately-formed fiber webs together to form a multi-web structure. Each of the fiber webs may have a different average fiber diameter. In some embodiments, one or more of the webs(s) (e.g., 2 webs, 3 webs, 4 webs, all layers) may also have a relatively constant average fiber diameter across its thickness. In general, any suitable process (e.g., lamination, thermo-dot bonding, ultrasonic, calendering, glue-web, co-pleating, collation) for adhering the layers may be used. Such a process may result in a gradient in mean pore size across the thickness of filter media, as described herein.

During or after formation of a gradient portion, the gradient portion may be further processed according to a variety of known techniques. Optionally, additional layers can be formed and/or added to the gradient portion using processes such as lamination, thermo-dot bonding, ultrasonic, calendering, glue-web, co-pleating, or collation. For example, more than one layer (e.g., meltblown layers, non-gradient layer) may be joined together by thermo-dot bonding, calendering, a glue web, or ultrasonic processes to form a layer (e.g., the second layer).

A non-gradient layer(s) described herein may be produced using any suitable processes, such as using a wet laid process (e.g., a process involving a pressure former, a rotoformer, a fourdrinier, a hybrid former, or a twin wire process) or a non-wet laid process (e.g., a dry laid process, an air laid process, a meltblowing process, an electrospinning process, a centrifugal spinning process, or a carding process). In some embodiments, the filter media may undergo further processing after formation. In some embodiments, further processing may involve pleating. In some cases, the filter media, or various layers thereof, may be suitably pleated by forming score lines at appropriately spaced distances apart from one another, allowing the filter media to be folded. It should be appreciated that any suitable pleating technique may be used.

It should be appreciated that the filter media may include other parts in addition to the one or more layers described herein. In some embodiments, further processing includes incorporation of one or more structural features and/or stiffening elements. For instance, the filter media may be combined with additional structural features such as polymeric and/or metallic meshes. In one embodiment, a screen backing may be disposed on the filter media, providing for further stiffness. In some cases, a screen backing may aid in retaining the pleated configuration. For example, a screen backing may be an expanded metal wire or an extruded plastic mesh.

In some embodiments, a layer described herein may be a non-woven web. A non-woven web may include non-oriented fibers (e.g., a random arrangement of fibers within the web). Examples of non-woven webs include webs made by wet-laid or non-wet laid processes as described herein. Non-woven webs also include papers such as cellulose-based webs.

Filter media described herein may be used in an overall filtration arrangement or filter element. In some embodiments, one or more additional layers or components are included with the filter media. Non-limiting examples of additional layers (e.g., a third layer, a fourth layer) include a meltblown layer, a wet laid layer, a spunbond layer, a carded layer, an air-laid layer, a spunlace layer, a forcespun layer (e.g., centrifugal spun layer), or an electrospun layer.

The filter media may be incorporated into a variety of suitable filter elements for use in various applications including gas and liquid filtration. Filter media suitable for gas filtration may be used for HVAC, HEPA, face mask, and ULPA filtration applications. For example, the filter media may be used in heating and air conditioning ducts. In another example, the filter media may be used for respirator and face mask applications (e.g., surgical face masks, industrial face masks and industrial respirators). Filter elements may have any suitable configuration as known in the art including bag filters and panel filters. Filter assemblies for filtration applications can include any of a variety of filter media and/or filter elements. The filter elements can include the above-described filter media. Examples of filter elements include gas turbine filter elements, dust collector elements, heavy duty air filter elements, automotive air filter elements, air filter elements for large displacement gasoline engines (e.g., SUVs, pickup trucks, trucks), HVAC air filter elements, HEPA filter elements, ULPA filter elements, vacuum bag filter elements, fuel filter elements, and oil filter elements (e.g., lube oil filter elements or heavy duty lube oil filter elements).

Filter elements can be incorporated into corresponding filter systems (gas turbine filter systems, heavy duty air filter systems, automotive air filter systems, HVAC air filter systems, HEPA filter systems, ULPA filter system, vacuum bag filter systems, fuel filter systems, and oil filter systems). The filter media can optionally be pleated into any of a variety of configurations (e.g., panel, cylindrical).

Filter elements can also be in any suitable form, such as radial filter elements, panel filter elements, or channel flow elements. A radial filter element can include pleated filter media that are constrained within two open wire meshes in a cylindrical shape. During use, fluids can flow from the outside through the pleated media to the inside of the radial element.

In some cases, the filter element includes a housing that may be disposed around the filter media. The housing can have various configurations, with the configurations varying based on the intended application. In some embodiments, the housing may be formed of a frame that is disposed around the perimeter of the filter media. For example, the frame may be thermally sealed around the perimeter. In some cases, the frame has a generally rectangular configuration surrounding all four sides of a generally rectangular filter media. The frame may be formed from various materials, including for example, cardboard, metal, polymers, or any combination of suitable materials. The filter elements may also include a variety of other features known in the art, such as stabilizing features for stabilizing the filter media relative to the frame, spacers, or any other appropriate feature.

As noted above, in some embodiments, the filter media can be incorporated into a bag (or pocket) filter element. A bag filter element may be formed by any suitable method, e.g., by placing two filter media together (or folding a single filter media in half), and mating three sides (or two if folded) to one another such that only one side remains open, thereby forming a pocket inside the filter. In some embodiments, multiple filter pockets may be attached to a frame to form a filter element. It should be understood that the filter media and filter elements may have a variety of different constructions and the particular construction depends on the application in which the filter media and elements are used. In some cases, a substrate may be added to the filter media.

The filter elements may have the same property values as those noted above in connection with the filter media. For example, the above-noted initial pressure drop, pressure drop over time, thicknesses, and/or basis weight may also be found in filter elements.

During use, the filter media mechanically trap contaminant particles on the filter media as fluid (e.g., air) flows through the filter media. The filter media need not be electrically charged to enhance trapping of contamination. Thus, in some embodiments, the filter media are not electrically charged. However, in some embodiments, the filter media may be electrically charged.

### EXAMPLES

### Example 1

This example describes the pressure drop of a waved filter media including a filtration layer containing a coarse fiber web and a fine fiber web and the pressure drop of a waved filter media including a filtration layer containing a coarse fiber web but not a fine fiber web. The filter media containing the filtration layer including the fine fiber web had a lower initial pressure drop and change in pressure drop over time

Both waved filter media contained a filtration layer positioned between two carded fiber webs including synthetic fibers having an average fiber diameter of about 15 microns. Waved filter media 1 included a filtration layer containing a meltblown fiber web and an electrospun fiber web. The meltblown fiber web included polypropylene fibers having an average fiber diameter of 1.8 microns and a basis weight of 14 g/m² and the electrospun layer including nylon fibers having an average fiber diameter of about 0.08 microns and a basis weight of 0.2 g/m². Waved filter media 2 included a filtration layer containing the same meltblown fiber web as waved filter media 1, but did not include the electrospun layer.

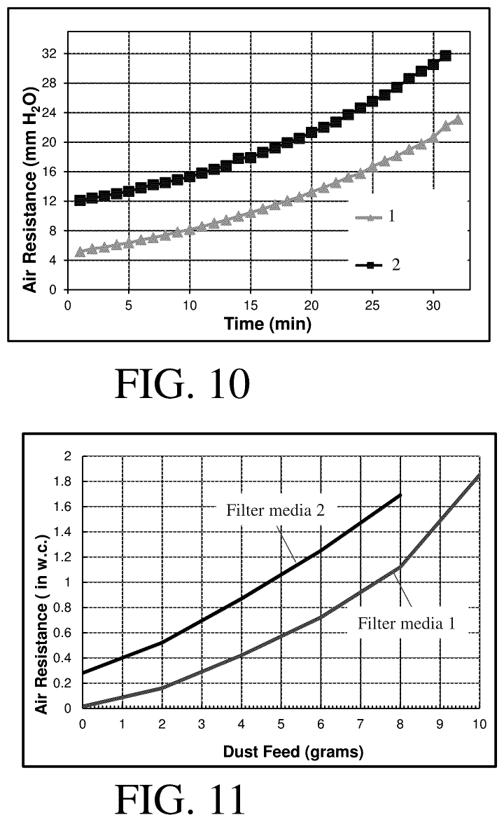

The initial pressure drop and pressure drop over time were determined on a 100 cm² sample of each waved filter media. In FIG. 10, the initial pressure drop was determined prior to loading with NaCl. The pressure drop over time was measured during loading of 35 mg of NaCl aerosol using an automated filter testing unit (e.g. 8130 CertiTest™ from TSI, Inc) equipped with a sodium chloride generator. The NaCl particles in the aerosol had an average diameter of 0.3 microns. During NaCl loading, the face velocity was 14 cm/s and the sample was loaded for 30 minutes.

In FIG. 11, the initial pressure drop and pressure drop over time was also determined during a dust holding capacity test conducted according to EN779 2012. The dust had a face velocity of 12.7 cm/s and the dust holding capacity was measured until at least a pressure of 1.7 in. W.C. was reached.

A graph of the pressure drop versus time and pressure drop versus dust feed are shown in FIG. 10 and FIG. 11, respectively.

As shown in FIGS. 10 and 11, filter media 1 had a lower initial pressure drop during salt and dust loading, respectively, than filter media 2.

### Example 2

This example describes a simulation of the performance of two filter media having a gradient characterized by two mathematical equations and a filter media lacking a gradient. The filter media having the gradient had a lower initial pressure drop and change in pressure drop after 25 minutes of NaCl loading.

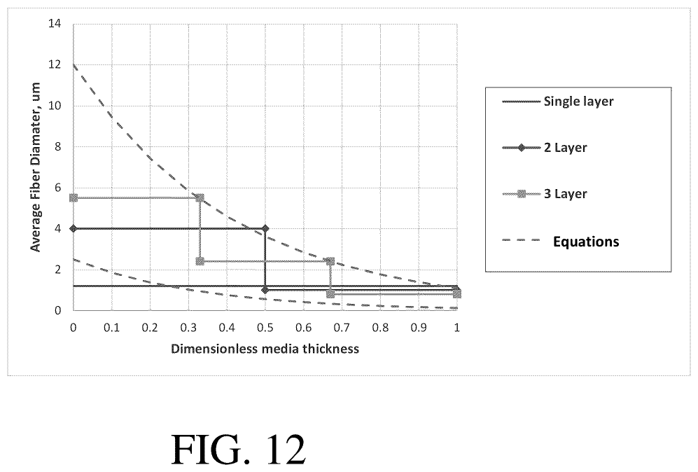

The simulation was performed using software that can simulate the performance characteristics of waved filter media. A computational model of a waved filter media including a filtration layer containing two meltblown layers (two layer), a waved filter media including a filtration layer containing three meltblown layers (three layer), and a waved filter media including a filtration layer containing one meltblown layer (one layer) was constructed. The three waved filter media had the same basis weight and efficiency. For the filtration layer containing two layers, each layer had a basis weight of 9 g/m². The most upstream layer had an average fiber diameter of 4 microns and the most downstream layer had an average fiber diameter of 1 micron. Some of the average fiber diameters in the filtration layer containing two layers fell outside of the mathematical equations. However, greater than or equal to about 90% of the average fiber diameters fell within the area defined by the mathematical equations. For the filtration layer containing three layers, each layer had a basis weight of 6 g/m². The most upstream layer had an average fiber diameter of 5.5 microns, the middle layer had an average fiber diameter of 2.4 microns, and the most downstream layer had an average fiber diameter of 0.8 microns. The single filtration layer had a basis weight of 18 g/m² and an average fiber diameter of 1.2 microns. FIG. 12 shows the change in average fiber diameter across the dimensionless thickness of the filtration layer. FIG. 12 also shows the mathematical equations that characterize the gradients in the waved filter media containing two layers and the waved filter media containing two layers. The Aₘₐₓ, Aₘᵢₙ, Bₘₐₓ, Bₘᵢₙ of the mathematical equations were 1.5, 1.2, 12, and 2.5, respectively. A simulation of pressure drop during NaCl loading was run for each waved filter media.

TABLE 1
Properties of Waved Filter Media

| | | Pressure Drop after |
|---|---|---|
| | Initial Pressure Drop | 25 min NaCl Loading |
| Filtration Layer | (mm H₂O) | (mm H₂O) |
| Single layer | 12 | 25.5 |
| 2 layer | 11 | 22.8 |
| 3 layer | 10.5 | 21.4 |

The waved filter media having a gradient in average fiber diameter characterized by two mathematical equations had a lower initial pressure drop and change in pressure drop over time after 25 minutes of NaCl loading as shown in Table 1.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A filter media, comprising:
a filtration layer comprising a coarse fiber web positioned adjacent to a fine fiber web, wherein an average fiber diameter at one or more locations along a thickness of the fine fiber web and an average fiber diameter at one or more locations along a thickness of the coarse fiber web is greater than or equal to any exponential function having the form:
$$\frac{{B}_{max}}{{( exp ( {A}_{min} * x ) )}^{2}}$$
and less than or equal to any exponential function having the form:
$$\frac{{B}_{max}}{{( exp ( {A}_{min} * x ) )}^{2}}$$
wherein:
Bₘᵢₙ is greater than or equal to about 1.5 microns and less than or equal to about 3 microns,
Bₘₐₓ is greater than or equal to about 12 microns and less than or equal to about 30 microns,
Aₘᵢₙ is greater than about 0 and less than or equal to about 1.2,
Aₘₐₓ is greater than or equal to about 1.4 and less than or equal to about 1.75,
x corresponds to a location along a thickness of at least a portion of the filtration layer and is normalized to have a value greater than or equal to 0 and less than or equal to 1, and
wherein:
the one or more locations along the thickness of the fine fiber web comprises a half thickness location of the fine fiber web, and
the one or more locations along the thickness of the coarse fiber web comprises a half thickness location of the coarse fiber web; and
a support layer.

2. The filter media of claim 1, wherein the support layer holds the filtration layer in a waved configuration and maintains separation of peaks and troughs of adjacent waves of the filtration layer.

3. The filter media of claim 1, wherein Bₘᵢₙ is greater than or equal to 2.5 microns and less than or equal to 3 microns.

4. The filter media of claim 1, wherein Bₘₐₓ is greater than or equal to 12 microns and less than or equal to 18 microns.

5. The filter media of claim 1, wherein Aₘᵢₙ is greater than or equal to 1.1 and less than or equal to 1.2.

6. The filter media of claim 1, wherein Aₘₐₓ is greater than or equal to 1.4 and less than or equal to 1.5.

7. The filter media of claim 1, wherein the coarse fiber web is charged.

8. The filter media of claim 1, wherein the fine fiber web is an electrospun fiber web.

9. The filter media of claim 1, wherein the coarse fiber web is a meltblown fiber web.

10. The filter media of claim 1, wherein the filter media comprises a second support layer.

11. The filter media of claim 1, wherein the fine fiber web has an average fiber diameter of greater than or equal to 0.1 microns and less than or equal to 15 microns.

12. The filter media of claim 1, wherein the coarse fiber web has an average fiber diameter of greater than or equal to 0.5 microns and less than or equal to 25 microns.

13. The filter media of claim 1, wherein the filtration layer has a mean flow pore size of greater than or equal to 10 microns and less than or equal to 30 microns.

14. The filter media of claim 1, wherein the coarse fiber web has a mean flow pore size of greater than or equal to 20 microns.

15. The filter media of claim 1, wherein the fine fiber web has a basis weight of greater than or equal to 2 g/m² and less than or equal to 30 g/m².

16. The filter media of claim 1, wherein the coarse fiber web has a basis weight of greater than or equal to 3 g/m² and less than or equal to 40 g/m².

17. The filter media of claim 1, wherein Bₘᵢₙ is greater than or equal to 2.5 microns and less than or equal to 3 microns; Bₘₐₓ is greater than or equal to 12 microns and less than or equal to 18 microns; Aₘᵢₙ is greater than or equal to 1.1 and less than or equal to 1.2; and Aₘₐₓ is greater than or equal to 1.4 and less than or equal to 1.5.

18. The filter media of claim 1, wherein the fine fiber web is an electrospun fiber web and the coarse fiber web is a meltblown fiber web.

19. The filter media of claim 18, wherein the coarse fiber web is charged and has a mean flow pore size of greater than or equal to 20 microns.

20. The filter media of claim 19, wherein Bₘᵢₙ is greater than or equal to 2.5 microns and less than or equal to 3 microns; Bₘₐₓ is greater than or equal to 12 microns and less than or equal to 18 microns; Aₘᵢₙ is greater than or equal to 1.1 and less than or equal to 1.2; and Aₘₐₓ is greater than or equal to 1.4 and less than or equal to 1.5.
